(19) United States
(12) Patent Application Publication
(10) Pub. No.: US 2022/0019124 A1
(43) Pub. Date: Jan. 20, 2022

(54) ON-CHIP BIDIRECTIONAL PULSE COMPRESSOR AND OPTICAL SYSTEM

(71) Applicant: Singapore University of Technology and Design, Singapore (SG)

(72) Inventor: Dawn Tan, Singapore (SG)

(21) Appl. No.: 16/931,471

(22) Filed: Jul. 17, 2020

(30) Foreign Application Priority Data
Jul. 16, 2020 (SG) 10202006818X

(51) Int. Cl. G02F 1/365; H01S 3/00

(52) U.S. Cl. CPC G02F 1/365; G02F 2203/26; H01S 3/0057

(57) ABSTRACT

An on-chip bidirectional pulse compressor for temporal compression and spectral compression. The on-chip bidirectional pulse compressor including a substrate; a nonlinear waveguide disposed on the substrate, wherein the nonlinear waveguide is dimensioned to induce a nonlinear response within a predetermined operating wavelength ranges and is made of a material free of two-photon absorption at the predetermined operating wavelength ranges; and an anomalous dispersive component disposed on the substrate. The nonlinear waveguide and the anomalous dispersive component are interconnected for bidirectional pulse propagation, wherein propagating through the nonlinear waveguide followed by the anomalous dispersive component causes temporal compression, and propagating through the anomalous dispersive component followed by the nonlinear waveguide causes spectral compression. Various embodiments also include an optical device including the on-chip bidirectional pulse compressor.

### CROSS-REFERENCE TO RELATED APPLICATIONS

The present application claims the benefit of the Singapore patent application No. 10202006818X filed on 16 Jul. 2020, the entire contents of which are incorporated herein by reference for all purposes.

### TECHNICAL FIELD

Various embodiments generally relate to an on-chip bidirectional pulse compressor and an optical system including the on-chip bidirectional pulse compressor.

### BACKGROUND

Optical pulse compression is a pulse shaping technique widely studied for application in optical systems. For example, optical system such as laser system, optical telecommunication system, high-speed optical computing and communication system may require specific temporal and/or spectral profiled optical pulses for operation. Conventionally, there are generally two main categories of pulse compressor. The first category is the soliton-effect optical compressor which enables pulse compression through simultaneous self-phase modulation (SPM) and group velocity dispersion occurring within the same component, for example an entire length of a piece of fiber or waveguide. The second category is a fiber-based or free-space optical compressor which uses two different components, for example a first fiber with SPM and a second fiber with dispersive elements. However, these are mainly for a single type of compression, such as temporal compression, and are usually of a large footprint in tens of meters.

Accordingly, there is a need for a smaller and a more versatile pulse compressor so as to address the above issues.

### SUMMARY

According to various embodiments, there is provided an on-chip bidirectional pulse compressor for temporal compression in a first propagation direction and spectral compression in a second propagation direction. The on-chip bidirectional pulse compressor may include a substrate. The on-chip bidirectional pulse compressor may include a nonlinear waveguide disposed on the substrate, wherein the nonlinear waveguide may be dimensioned and made or a material to induce a nonlinear response within a predetermined operating wavelength ranges, wherein the material of the nonlinear waveguide is free of two-photon absorption at the predetermined operating wavelength ranges. The on-chip bidirectional pulse compressor may include an anomalous dispersive component disposed on the substrate. The nonlinear waveguide and the anomalous dispersive component may be interconnected for bidirectional pulse propagation. When a pulse propagates in the first propagation direction through the nonlinear waveguide followed by the anomalous dispersive component, the nonlinear waveguide may induce self-phase modulation to broaden a spectrum of the pulse and the anomalous dispersive component may subsequently induce anomalous dispersion to temporally shift frequency components of the broadened spectrum towards a centre of the pulse in a manner so as to cause temporal compression of the pulse. When a pulse propagates in the second propagation direction through the anomalous dispersive component followed by the nonlinear waveguide, the anomalous dispersive component may induce anomalous dispersion on the pulse to temporally shift frequency components of a spectrum of the pulse such that higher frequency components of the spectrum advance ahead relative to lower frequency components of the spectrum and the nonlinear waveguide may subsequently induce self-phase modulation to redshift the higher frequency components of the spectrum which are leading and blueshift the lower frequency components of the spectrum which are trailing in a manner so as to cause spectral compression of the pulse.

According to various embodiments, there is provided an optical system. The system may include a pulse emitter operable to emit a pulse within a predetermined operating wavelength ranges. The system may include a pulse receiver. The system may include an on-chip bidirectional pulse compressor disposed along a transmission path between the pulse emitter and the pulse receiver. The on-chip bidirectional pulse compressor may include a substrate. The on-chip bidirectional pulse compressor may include a nonlinear waveguide disposed on the substrate, wherein the nonlinear waveguide may be dimensioned and made of a material to induce a nonlinear response within the predetermined operating wavelength ranges, wherein the material of the nonlinear waveguide is free of two-photon absorption at the predetermined operating wavelength ranges. The on-chip bidirectional pulse compressor may include an anomalous dispersive component disposed on the substrate, wherein the nonlinear waveguide and the anomalous dispersive component may be interconnected for bidirectional pulse propagation. The on-chip bidirectional pulse compressor may include a first input/output interface associated with the nonlinear waveguide. The on-chip bidirectional pulse compressor may include a second input/output interface associated with the anomalous dispersive component. The system may further include a transmission path switching mechanism configured to switch between a first transmission path and a second transmission path. In the first transmission path, the pulse emitter may emit the pulse to the first input/output interface for propagating the pulse through the on-chip bidirectional pulse compressor in a first propagation direction through the nonlinear waveguide followed by the anomalous dispersive component, wherein the nonlinear waveguide may induce self-phase modulation to broaden a spectrum of the pulse and the anomalous dispersive element may subsequently induce anomalous dispersion to temporally shift frequency component of the broadened spectrum towards a centre of the pulse in a manner so as to output a temporally compressed pulse from the second input/output interface to the pulse receiver. In the second transmission path, the pulse emitter may emit the pulse to the second input/output interface for propagating the pulse through the on-chip bidirectional pulse compressor in a second propagation direction through the anomalous dispersive component followed by the nonlinear waveguide, wherein the anomalous dispersive component may induce anomalous dispersion on the pulse to temporally shift frequency component of a spectrum of the pulse such that higher frequency components of the spectrum advance ahead relative to lower frequency components of the spectrum and the nonlinear waveguide may subsequently induce self-phase modulation to redshift the higher frequencies of the spectrum which are leading and blueshift the lower frequencies of the spectrum which are trailing in a manner so as to output a spectrally compressed pulse from the first input/output interface to the pulse receiver.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1A shows a schematic diagram of an on-chip bidirectional pulse compressor according to various embodiments;

FIG. 1B shows a schematic diagram of an on-chip bidirectional pulse compressor according to various embodiments;

FIG. 2A shows a schematic diagram of an on-chip bidirectional pulse compressor according to various embodiments;

FIG. 2B shows a layered arrangement of the on-chip bidirectional pulse compressor of FIG. 2A according to various embodiments;

FIG. 2C shows a variant of an anomalous dispersive component for the on-chip bidirectional pulse compressor of FIG. 2A according to various embodiments;

FIG. 3A and FIG. 3B show the measured output spectra and temporal pulses based on experiments conducted with the on-chip bidirectional pulse compressor of FIG. 2A according to various embodiments;

FIG. 3C shows the measured FWHM (full width half maximum) as a function of input peak power based on experiments conducted with the on-chip bidirectional pulse compressor of FIG. 2A according to various embodiments;

FIG. 3D shows the measured and theoretical temporal pulses plotted along with input pulse at Pᵢₙ=9 W for the on-chip bidirectional pulse compressor of FIG. 2A according to various embodiments;

FIG. 3E shows the theoretical calculations of temporal pulse evolution as a function of normalized interaction length for the on-chip bidirectional pulse compressor of FIG. 2A according to various embodiments;

FIG. 4A shows the measured pulse spectrum as the peak input power is increased based on experiments conducted with the on-chip bidirectional pulse compressor of FIG. 2A according to various embodiments;

FIG. 4B shows 10 dB bandwidth of spectrally compressed pulses as the input pulse peak power is increased based on experiments conducted with the on-chip bidirectional pulse compressor of FIG. 2A according to various embodiments; and

FIG. 5A to FIG. 5D show optical systems including the on-chip bidirectional pulse compressor of FIG. 1A to FIG. 2A according to various embodiments.

### DETAILED DESCRIPTION

Embodiments described below in the context of the apparatus are analogously valid for the respective methods, and vice versa. Furthermore, it will be understood that the embodiments described below may be combined, for example, a part of one embodiment may be combined with a part of another embodiment.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

Various embodiments generally relate to a pulse compressor. According to various embodiments, the pulse compressor may be an optical pulse compressor. According to various embodiments, the pulse compressor may be configured to be used for magnifying or de-magnifying a pulse or an optical pulse in both time and spectrum. According to various embodiments, the pulse compressor may be configured to be capable of performing two distinct type of pulse manipulation depending on the pulse propagation direction through the pulse compressor. According to various embodiments, the pulse compressor may be capable of manipulating the pulse temporal profile in a first propagation direction and the pulse spectrum in a second propagation direction. The first propagation direction and the second propagation direction may be opposite directions or reverse of each other. Accordingly, spectral and temporal manipulation of the pulse of the optical pulse may be achieved in the same pulse compressor of the various embodiments. Hence, manipulation of both pulse spectrum and pulse temporal profile may be achieved by using one single pulse compressor.

According to various embodiments, the pulse compressor may be a bidirectional pulse compressor or a reversible pulse compressor which can be used in both directions. When being used in the first propagation direction, the bidirectional pulse compressor of the various embodiments may temporally compress the pulse. When being used in the second propagation direction or a reverse propagation direction, the bidirectional pulse compressor of the various embodiments may spectrally compress the pulse. Accordingly, the bidirectional pulse compressor of the various embodiments may be used with inputs and outputs reversed to create both temporal compression and spectral compression. Hence, the bidirectional pulse compressor according to the various embodiments may be used interchangeable with input and output reversed depending on whether temporal compression or spectral compression is desired.

According to various embodiments, the pulse compressor may be an on-chip system. Accordingly, components of the pulse compressor may be integrated on a single chip or substrate. Therefore, the pulse compressor may be an on-chip bidirectional pulse compressor or an on-chip bidirectional optical pulse compressor. Accordingly, both spectral and temporal compression may be achieved in the same on-chip system. According to various embodiments, the on-chip bidirectional pulse compressor may have a small footprint or form factors, for example 1 mm by 0.5 μm, which makes it easy to be used or applied in optical devices or optical system. Being an on-chip system may also enable various embodiments to be incorporated into applications that require small form factors.

Various embodiments also generally relate to an optical system including the on-chip bidirectional pulse compressor. The optical system may include an emitter for emitting a pulse or an optical pulse, and a receiver. The on-chip bidirectional pulse compressor may be disposed along a transmission path between the emitter and the receiver. According to various embodiments, the optical system may be operated to propagate pulse from the emitter through the on-chip bidirectional pulse compressor interchangeably via the first propagation direction or the second propagation direction, which is reverse of the first propagation direction, depending on whether temporal compression or spectral compression is desired such that the on-chip bidirectional pulse compressor may output a temporally compressed or spectrally compressed pulse to the receiver.

According to various embodiments, the on-chip bidirectional pulse compressor may utilize two distinct stages to achieve either spectral or temporal compression. One of the stages may possess large dispersion and the other stage may possess high nonlinearity. When operated such that a pulse or an optical pulse or light enters the dispersion stage first, spectral compression or temporal expansion may occur. When operated such that a pulse or an optical pulse or light enters the nonlinear stage first, temporal compression or spectral expansion may occur. Various embodiments may provide a unique on-chip system that can achieve both spectral and temporal compression. Various embodiments may allow full control of an optical pulse's properties without energy loss.

According to various embodiments, the on-chip bidirectional pulse compressor may be a two-stage configuration including or consisting essentially of a dispersive stage and a nonlinear stage which are connected. According to various embodiment, the dispersion in the dispersive stage is anomalous.

According to various embodiments, if a pulse or an optical pulse or light enters the dispersive stage first, anomalous dispersion may create a linear frequency chirp where higher frequencies advance in time relative to shorter frequencies. In the subsequent nonlinear stage, self-phase modulation may cause the temporally faster frequencies to experience a downshift in frequencies and temporally slower frequencies experience an upshift in frequencies. This may cause spectral compression or equivalently, temporal expansion.

According to various embodiments, if a pulse or an optical pulse or light enters the nonlinear stage first, self-phase modulation (SPM) may impose a frequency chirp where newly generated frequencies vary with time. The subsequent dispersive stage may temporally shift the SPM-generated frequencies towards the centre of the pulse, resulting in temporal compression or equivalently, spectral expansion.

According to various embodiments, the degree of spectral or temporal compression may be controlled by configuring the dispersive stage and the nonlinear stage accordingly.

According to various embodiments, the ability to control an optical pulse's spectra-temporal properties provided by the various embodiments is an important function for optical system. For example, temporal compression of pulses may impact the capacity of optical information systems, or the resolution of metrology tools, while spectral compression may provide planned degrees of freedom for frequency-dense networks. Conventional methods of pulse compression only allow control of only one of temporal or spectral properties, or require non-integrated components that detract from industry's drive towards fully chip-scale systems. Therefore, various embodiments introduce an important new paradigm for spectra-temporal manipulation of optical pulses towards turn-key, integrated systems for all-optical pulse control.

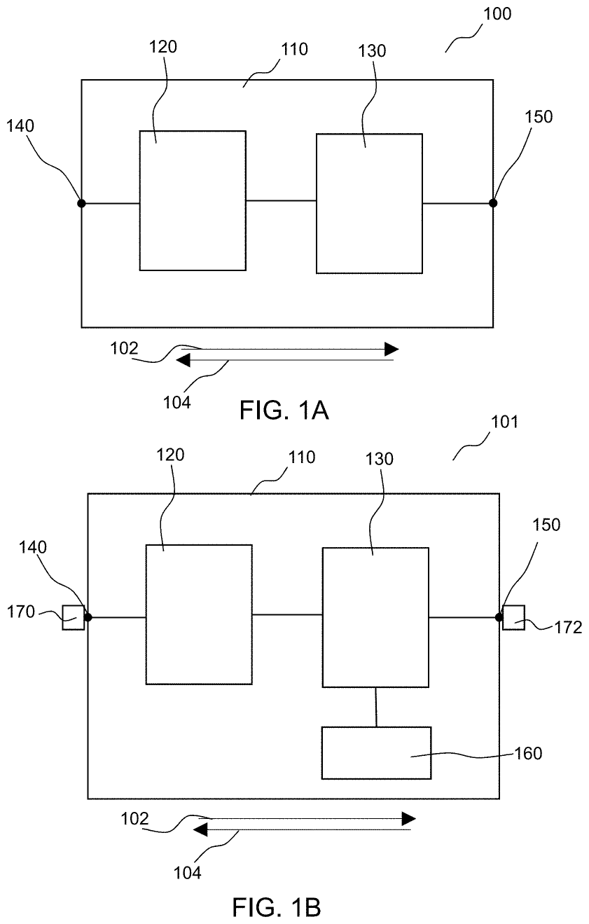

FIG. 1A shows a schematic diagram of an on-chip bidirectional pulse compressor 100 or an on-chip bidirectional optical pulse compressor according to various embodiments. According to various embodiments, the on-chip bidirectional pulse compressor 100 may be configured for temporal compression of a pulse or an optical pulse or light in a first propagation direction 102 and spectral compression of a pulse or an optical pulse or light in a second propagation direction 104. The first propagation direction 102 and the second propagation direction 104 may be opposite directions. Accordingly, the second propagation direction 104 may be reversed of the first propagation direction 102. According to various embodiments, the on-chip bidirectional pulse compressor 100 may include a substrate 110. The substrate 110 may be an underlying base or material or layer or support structure on which other materials or components may be formed or deposited. Accordingly, the substrate 110 may be the base of the on-chip system on which the pulse compressing components or circuits are integrated or formed or fabricated or embedded. With the substrate 110, the on-chip bidirectional pulse compressor 100 may be formed or built as a single integrated unitary device. According to various embodiments, the on-chip bidirectional pulse compressor 100 may include completely on-chip components with independent anomalous dispersive component and nonlinear component. According to various embodiments, the on-chip bidirectional pulse compressor 100 may have a small footprint or form factors, for example 1 mm by 0.5 μm, in contrast to the conventional fibre-based pulse compressor which is in tens of meters. Thus, the small footprint of the on-chip bidirectional pulse compressor 100 may make it easy to be used or applied in optical devices or optical system. Being an on-chip system may also enable the on-chip bidirectional pulse compressor 100 to be easily incorporated into applications that require small form factors.

According to various embodiments, the on-chip bidirectional pulse compressor 100 may include a nonlinear waveguide 120 or a nonlinear optical waveguide disposed on the substrate 110. The nonlinear waveguide 120 may include a structure that guides waves or pulses, such as electromagnetic waves or pulses, or optical waves or pulses, by restricting the propagation of waves or pulses to one direction along the nonlinear waveguide 120. For example, according to various embodiments, the nonlinear waveguide 120 may include, but not limited to: a solid strip waveguide structure having a rectangular cross-section profile; a solid strip waveguide structure having a square cross-sectional profile; a solid strip waveguide structure having a circular cross-sectional profile; a slot waveguide structure having (or consisting essentially of) two strips or slabs next to each other with each having a rectangular or square cross-section profile; or a rib waveguide structure having (or consisting essentially of) a narrower strip superimposed on a wider slab with each of the narrower strip and the wider slab having a rectangular cross-section profile. According to various embodiments, the nonlinear waveguide 120 may have a width between 10 nm to 100 μm, or preferably between 50 nm to 50 μm, or preferably between 300 nm to 2 μm. According to various embodiments, the nonlinear waveguide 120 may have a thickness between 10 nm to 100 μm, or preferably 50 nm to 50 μm, or preferably between 300 nm to 2 μm.

According to various embodiments, the nonlinear waveguide 120 of the on-chip bidirectional pulse compressor 100 may be dimensioned and made of a material to induce a nonlinear response within a predetermined operating wavelength ranges of the pulse or the optical pulse or the light. According to various embodiments, the nonlinear response may include, but not limited to, optical Kerr effect whereby the refractive index of the nonlinear waveguide 120 is intensity-dependent. Further, the optical Kerr effect in the nonlinear waveguide 120 may be caused by temporal variation in the intensity creating a temporal variation in the refractive index which may result in self-phase modulation (SPM) of electromagnetic or optical pulses. According to various embodiments, the nonlinear waveguide 120 may be dimensioned to optimize SPM. According to various embodiments, the nonlinear waveguide 120 may be dimensioned to minimize the number of waveguide modes and field distributions. According to various embodiments, the material of the nonlinear waveguide 120 may have a nonlinear refractive index at the predetermined operating wavelength ranges of the pulse or the optical pulse or the light as an inherent material property. According to various embodiments, the nonlinear waveguide 120 may be dimensioned to strongly confine light into a small area to cause the interaction of the optical field to have a stronger nonlinear response. Accordingly, with the combination of the material and the waveguide dimensions, the nonlinear waveguide 120 may induce the desired nonlinear response within the predetermined operating wavelength ranges of the pulse or the optical pulse or the light.

According to various embodiments, the predetermined operating wavelength ranges may be the desired wavelength ranges of the pulse to be compressed. For example, for imaging purposes, the predetermined operating wavelength ranges may be within the visible wavelength range from 380 nm to 740 nm. For example, for sensing applications, the predetermined operating wavelength ranges may be within the mid-infrared wavelength range from 3 μm to 8 μm. For example, for terahertz radiation applications, the predetermined operating wavelength may be within the terahertz wavelength range from 10 μm to 1 mm. For example, for applications in optical system, the predetermined operating wavelength may be within the optical telecommunication wavelength ranges which range from 1260 nm to 1675 nm. Further, the predetermined operating wavelength may include the pre-defined sub-ranges within the optical telecommunication wavelength ranges such as the O-band ranging from 1260 nm to 1360 nm, the E-band ranging from 1360 nm to 1460 nm, the S-band ranging from 1460 nm to 1530 nm, the C-band ranging from 1530 nm to 1565 nm, the L-band ranging from 1565 nm to 1625 nm, the U-band ranging from 1625 nm to 1675 nm or any combination thereof.

According to various embodiments, the nonlinear waveguide 120 of the on-chip bidirectional pulse compressor 100 may be made of a material free of two-photon absorption at the predetermined operating wavelength ranges of the pulse or the optical pulse or the light. Accordingly, the material of the nonlinear waveguide 120 may be free of two-photon absorption at the predetermined operating wavelength ranges of the pulse or the optical pulse or the light. While two-photon absorption is a nonlinear optical phenomenon that occurs when two photons are simultaneously absorbed by a material, this is an undesirable phenomenon for the nonlinear waveguide 120 in the on-chip bidirectional pulse compressor 100 according to various embodiments. According to various embodiments, temporal compression in the first propagation direction 102 of the on-chip bidirectional pulse compressor 100 and spectral compression in the second propagation direction 104 of the on-chip bidirectional pulse compressor 100 is enabled by the absence of two-photon absorption at the predetermined operating wavelength ranges in the nonlinear waveguide 120. According to various embodiments, without the two-photon absorption at the predetermined operating wavelength ranges in the nonlinear waveguide 120, the nonlinear waveguide 120 may have low nonlinear losses to provide the necessary conditions for achieving temporal compression in the first propagation direction 102 of the on-chip bidirectional pulse compressor 100 and spectral compression in the second propagation direction 104 of the on-chip bidirectional pulse compressor 100. According to various embodiments, the material free of two-photon absorption may include a material having minimal or negligible two-photon absorption at the predetermined operating wavelength ranges of the pulse or the optical pulse or the light. According to various embodiments, the material having minimal or negligible two-photon absorption may have a low two-photon absorption coefficient. According to various embodiments, the low two-photon absorption coefficient may result in a large nonlinear figure of merit (FOM), which is defined later, wherein the FOM may be at least 4.5 at the predetermined operating wavelength ranges of the pulse or the optical pulse or the light.

For example, according to various embodiments, a material free of two-photon absorption within the optical telecommunication wavelength ranges for the nonlinear waveguide 120 may include, but not limited to, gallium arsenide (GaAs), aluminium gallium arsenide (AlGaAs), or ultra-silicon-rich nitride (USRN). However, materials such as silicon (Si) cannot be used because it has high nonlinear loss, in particular high two-photon absorption within these wavelength, which would not allow spectral compression to be achieved in the manner of the on-chip bidirectional pulse compressor 100 of the various embodiments. This is because, when there is high nonlinear losses, the required nonlinear phase for compression cannot be acquired and, hence, spectral compression may not be achievable. The high nonlinear loss will also limit the temporal compression and, hence, leading to ineffective temporal compression. Thus, commonly used optical waveguides, which are made from silicon (Si), may not be suitable to achieve the bidirectional compression in the manner of the on-chip bidirectional pulse compressor 100 of the various embodiments.

According to various embodiments, the nonlinear waveguide 120 of the on-chip bidirectional pulse compressor 100 may be of a high quality whereby the nonlinear waveguide 120 has a large nonlinear figure of merit (FOM). According to various embodiments, a large nonlinear FOM means that (i) the nonlinear waveguide 120 has no or minimal or negligible two-photon absorption at the predetermined operating wavelength ranges of the pulse or the optical pulse or the light and (ii) the nonlinear parameter, γ, is large. According to various embodiments, the nonlinear FOM from the standpoint of a material with or without two-photon absorption may be given by, FOM=n₂/α_{TPA}·λ, wherein n₂ is the nonlinear refractive index of the material, λ is the wavelength and α_{TPA} is the two photon absorption coefficient. Accordingly, for a material with no or minimal or negligible two photon absorption, the two photon absorption coefficient is very low. Hence, the FOM will be very high. According to various embodiments, the FOM may be at least 4.5 (i.e. equal to or greater than 4.5). According to various embodiments, the nonlinear parameter may be given by, γ=n₂·ω/c·A_{eff}, wherein eff n₂ is the nonlinear refractive index of the material, ω is the angular frequency, c is the speed of light in vacuum and A_{eff} is the effective mode area. According to various embodiments, the nonlinear parameter, γ, may be between 0.1 W⁻¹/m to 10,000 W⁻¹/m, or preferably between 10 W⁻¹/m to 1,000 W⁻¹/m, or preferably between 100 W⁻¹/m to 700 W⁻¹/m.

According to various embodiments, the material of the nonlinear waveguide 120 of the on-chip bidirectional pulse compressor 100 may be complementary metal oxide semiconductor (CMOS) compatible. Accordingly, the material of the nonlinear waveguide 120 may enable it to be fabricated using the manufacturing processes used for silicon electronics. For example, according to various embodiments, a CMOS compatible material free of two-photon absorption within the optical telecommunication wavelength ranges for the nonlinear waveguide 120 may include, but not limited to, USRN.

According to various embodiments, the USRN material may include amorphous, polycrystalline or crystalline material that contains both silicon (Si) and nitrogen (Ni). Further, in the USRN material, a quantity of the silicon (Si) is higher than stoichiometric silicon nitride (Si₃N₄). Accordingly, the quantitative relationships or ratios between silicon (Si) and nitrogen (Ni) in the USRN material is higher than that of stoichiometric silicon nitride (Si₃N₄).

According to various embodiments, the on-chip bidirectional pulse compressor 100 may include an anomalous dispersive component 130 disposed on the substrate 110. According to various embodiments, the anomalous dispersive component 130 may induce a differential group delay with respect to wavelength to induce dispersion of the pulse or the optical pulse or the light. According to various embodiments, in the anomalous dispersive component 130, the differential group delay may decrease with increasing frequency (or decreasing wavelength) component within the predetermined operating wavelength ranges of the pulse or the optical pulse or the light to induce anomalous dispersion of the pulse or the optical pulse or the light.

According to various embodiments, the anomalous dispersive component 130 of the on-chip bidirectional pulse compressor 100 may be configured to induce anomalous dispersion based on a linear relationship between the differential group delay and the frequency (or wavelength) component within the predetermined wavelength ranges. According to various embodiments, the anomalous dispersive component 130 may be configured such that the differential group delay may decrease linearly with increasing frequency (or decreasing wavelength) components within the predetermined operating wavelength ranges. Accordingly, when the pulse or the optical pulse or the light propagates through the anomalous dispersive component 130, higher frequency (or shorter wavelength) components may experience less delay and advance faster in time relative to lower frequency (or longer wavelength) components.

According to various embodiments, the anomalous dispersive component 130 of the on-chip bidirectional pulse compressor 100 may be of a high quality whereby the anomalous dispersive component 130 exhibits minimal group delay ripples. According to various embodiments, group delay ripple is the deviation from the linear profile of the relationship between the differential group delay and the frequency (or wavelength) component within the predetermined wavelength ranges. According to various embodiments, the minimal group delay ripples is relative to the compressed pulse width of the output pulse (i.e. the pulse exiting the pulse compressor 100). For example, when the compressed pulse width of the output pulse is wide, larger group delay ripples may be tolerated. According to various embodiments, the minimal group delay ripples may be a threshold whereby compression can or cannot occur for a compressed pulse width of the output pulse.

According to various embodiments, the anomalous dispersive component 130 of the on-chip bidirectional pulse compressor 100 may include anomalous dispersive solid physical structures or arrangement suitable to be integrated into the on-chip system and made of materials through which the pulse or the optical pulse or the light may propagate. According to various embodiments, the anomalous dispersive component 130 in the form of the anomalous dispersive solid physical structures or arrangement may be shaped and/or arranged and/or dimensioned so as to induce anomalous dispersion on the pulse or the optical pulse or the light propagating therethrough. For example, the anomalous dispersive component 130 in the form of the anomalous dispersive solid physical structures or arrangement may include, but not limited to, gratings and/or ripples and/or corrugations and/or ribs and/or slots and/or claddings and/or layering and/or shapes which induces anomalous dispersion on the pulse or the optical pulse or the light propagating therethrough. The anomalous dispersive component 130 in the form of the anomalous dispersive solid physical structures or arrangement may also include, but not limited to, parallel structures and/or adjacent structures and/or spaced apart structures and/or opposing structures which induces anomalous dispersion on the pulse or the optical pulse or the light propagating therethrough.

According to various embodiments, the anomalous dispersive component 130 of the on-chip bidirectional pulse compressor 100 may be made of the material suitable for the nonlinear waveguide 120 of the on-chip bidirectional pulse compressor 100, or the same material as the nonlinear waveguide 120 of the on-chip bidirectional pulse compressor 100. According to various embodiments, the anomalous dispersive component 130 and the nonlinear waveguide 120 may be two separate components joined or combined or integrated together onto the substrate 110 to form the on-chip bidirectional pulse compressor 100 as a single unit. According to various embodiments, the anomalous dispersive component 130 and the nonlinear waveguide 120 may be integrally formed on the substrate in a manner so as to form a continuous monolithic structure. Accordingly, the anomalous dispersive component 130 and the nonlinear waveguide 120 may be made of the same material. For example, when the nonlinear waveguide 120 is made of the USRN material, the anomalous dispersive component 130 may be also made of the USRN material. According to various embodiments, the continuity between the nonlinear waveguide 120 and the anomalous dispersive component 130 as a continuous monolithic structure may bring about low loss, compactness and ease of manufacturing.

According to various embodiments, the anomalous dispersive component 130 of the on-chip bidirectional pulse compressor 100 may be configured to induce anomalous dispersion during transmission or propagation of the pulse or the optical pulse or the light through the anomalous dispersive component 130 and not via reflection. Thus, the on-chip bidirectional pulse compressor 100 may not require additional component, such as an optical circulator, for rerouting of the pulse or the optical pulse or the light. Accordingly, the on-chip bidirectional pulse compressor 100 may be free of or without the optical circulator for rerouting the pulse or the optical pulse or the light to and/or from the anomalous dispersive component 130.

According to various embodiments, in operation, the pulse or the optical pulse or the light may be propagated through the on-chip bidirectional pulse compressor 100 in the first propagation direction 102 for temporal compression of the pulse or the optical pulse or the light, and the pulse or the optical pulse or the light may be propagated through the on-chip bidirectional pulse compressor 100 in the second propagation direction 104 for spectral compression of the pulse or the optical pulse or the light. According to various embodiments, when the pulse or the optical pulse or the light is propagating in the first propagation direction 102, the pulse or the optical pulse or the light may propagate through the components of the on-chip bidirectional pulse compressor 100 in the order or sequence of the nonlinear waveguide 120 followed by the anomalous dispersive component 130. According to various embodiments, when the pulse or the optical pulse or the light is propagating in the second propagation direction 104, the pulse or the optical pulse or the light may propagate through the components of the on-chip bidirectional pulse compressor 100 in the order or sequence of the anomalous dispersive component 130 followed by the nonlinear waveguide 120.

According to various embodiments, when the pulse or the optical pulse or the light propagates in the first propagation direction 102 through the nonlinear waveguide 120 followed by the anomalous dispersive component 130, the nonlinear waveguide 120 may induce self-phase modulation on the pulse or the optical pulse or the light to broaden a spectrum of the pulse or the optical pulse or the light so as to increase the frequency (or wavelength) components of the pulse or the optical pulse or the light. During the self-phase modulation, the pulse or the optical pulse or the light may undergo a phase shift to broaden the spectrum of the pulse or the optical pulse or the light. Subsequently, the anomalous dispersive component 130 may induce anomalous dispersion to temporally shift the frequency (or wavelength) components of the broadened spectrum towards a centre of the pulse or the optical pulse. During anomalous dispersion, the linearly varied differential group delay may cause higher frequency (or shorter wavelength) components to temporally move faster due to less time delay and lower frequency (or longer wavelength) components to temporally move slower due to more time delay resulting in temporal compression of the pulse or the optical pulse or the light. In this manner, propagation through the on-chip bidirectional pulse compressor 100 in the first propagation direction 102 may cause temporal compression of the pulse or the optical pulse or the light.

According to various embodiments, when the pulse or the optical pulse or the light propagates in the second propagation direction through the anomalous dispersive component 130 followed by the nonlinear waveguide 120, the anomalous dispersive component 130 may induce anomalous dispersion on the pulse to temporally shift the frequency (or wavelength) components of a spectrum of the pulse such that higher frequency (or shorter wavelength) components of the spectrum advance ahead in time relative to lower frequency (or longer wavelength) components of the spectrum. During anomalous dispersion, the linearly varied differential group delay may cause a linear frequency chirp whereby higher frequency (or shorter wavelength) components may temporally move faster due to less time delay and lower frequency (or longer wavelength) components may temporally move slower due to more time delay resulting in an anomalous dispersion or a reverse of the normal dispersion of the pulse or the optical pulse or the light. Subsequently, the nonlinear waveguide 120 may induce self-phase modulation to redshift (or upshift) the higher frequency (or shorter wavelength) components of the spectrum which are leading and blueshift (or downshift) the lower frequency (or longer wavelength) components of the spectrum which are trailing. During the self-phase modulation, the pulse or the optical pulse or the light may undergo a phase shift to redshift (or upshift) the leading frequency (or wavelength) components, i.e. frequency components that are temporally faster, and blueshift (or downshift) the trailing frequency (or wavelength) components, i.e. frequency components that are temporally slower. Since the leading frequency (or wavelength) components are the higher frequency (or shorter wavelength) components of the spectrum and the trailing frequency (or wavelength) components are the lower frequency (or longer wavelength) components of the spectrum, the phase shift due to self-phase modulation causes the frequency (or wavelength) components of the spectrum to shift towards a centre of the spectrum to result in spectral compression. In this manner, propagation through the on-chip bidirectional pulse compressor 100 in the second propagation direction 104 may cause spectral compression of the pulse or the optical pulse or the light.

According to various embodiments, a degree of spectral compression and/or temporal compression of the on-chip bidirectional pulse compressor 100 may be varied or controlled via configuring the nonlinear waveguide 120 and/or the anomalous dispersive component 130. Accordingly, a desired degree of spectral compression and temporal compression to be achieved by the on-chip bidirectional pulse compressor 100 may be achieved by varying or adjusting a configuration of the nonlinear waveguide 120 and the anomalous dispersive component 130.

According to various embodiments, the on-chip bidirectional pulse compressor 100 may include a first input/output interface 140 associated with the nonlinear waveguide 120 and a second input/output interface 150 associated with the anomalous dispersive component 130. Accordingly, the first input/output interface 140 and the nonlinear waveguide 120 are in a one-to-one relationship whereby any pulse or optical pulse or light may transmit directly between the first input/output interface 140 and the nonlinear waveguide 120. Similarly, the second input/output interface 150 and the anomalous dispersive component 130 are in a one-to-one relationship whereby any pulse or optical pulse or light may transmit directly between the second input/output interface 150 and the anomalous dispersive component 130. According to various embodiments, each of the first input/output interface 140 and the second input/output interface 150 may be configured to serve and function as both input and output. According to various embodiments, when the on-chip bidirectional pulse compressor 100 is used for temporal compression in the first propagation direction 102, the first input/output interface 140 may serve as an input interface for receiving the pulse or the optical pulse or the light, and the second input/output interface 150 may serve as an output interface to output the temporally compressed pulse or optical pulse or light. According to various embodiments, when the on-chip bidirectional pulse compressor 100 is used for spectral compression in the second propagation direction 104, the second input/output interface 150 may serve as an input interface for receiving the pulse or the optical pulse or the light, and the first input/output interface 140 may serve as an output interface to output the spectrally compressed pulse or optical pulse or light. According to various embodiments, the on-chip bidirectional pulse compressor 100 may include only two input/output interface 150, i.e. the first input/output interface 140 and the second input/output interface 150.

FIG. 1B shows a schematic diagram of an on-chip bidirectional pulse compressor 101 or an on-chip bidirectional optical pulse compressor according to various embodiments. According to various embodiments, the on-chip bidirectional pulse compressor 101 of FIG. 1B may contain all the features of the on-chip bidirectional pulse compressor 100 of FIG. 1A. Accordingly, all features, changes, modifications, and variations that are applicable to the on-chip bidirectional pulse compressor 100 of FIG. 1A may also be applicable to the on-chip bidirectional pulse compressor 101 of FIG. 1B. According to various embodiments, the on-chip bidirectional pulse compressor 101 of FIG. 1B may, similar to the on-chip bidirectional pulse compressor 100 of FIG. 1A, include the substrate 110, the nonlinear waveguide 120, the anomalous dispersive component 130, the first input/output interface 140 and the second input/output interface 150. According to various embodiments, the on-chip bidirectional pulse compressor 101 of FIG. 1B may further include the following additional features and/or limitations.

According to various embodiments, the on-chip bidirectional pulse compressor 101 of FIG. 1B may further include a thermo-optic tuning component 160 coupled to the anomalous dispersive component 130 for active control of the anomalous dispersion. According to various embodiments, the thermo-optic tuning component 160 may include a heater element or a resonator element coupled to the anomalous dispersive component 130 and a knob or switch configured to control the operation of the heater element or the resonator so as to control the heating for thermos-optic tuning of the anomalous dispersive component 130. According to various embodiments, the heater element or the resonator element of the thermos-optic tuning component 160 may be integrated into the on-chip bidirectional pulse compressor 101. For example, the heater element or the resonator element of the thermos-optic tuning component 160 may be embedded into the substrate 110 or may be sandwiched between the substrate 110 and the anomalous dispersive component 130 or may be attached on the anomalous dispersive component 130.

According to various embodiments, the on-chip bidirectional pulse compressor 101 of FIG. 1B may further include a first waveguide coupler 170 coupled to the first input/output interface 140 associated with the nonlinear waveguide 120 and a second waveguide coupler 172 coupled to the second input/output interface 150 associated with the anomalous dispersive component 130. According to various embodiments, the first waveguide coupler 170 and the second waveguide coupler 172 may enable easy coupling of the on-chip bidirectional pulse compressor 101 to an emitter or a receiver or a transmission line. According to various embodiments, each of the first waveguide coupler 170 and the second waveguide coupler 172 may be configured to provide a smooth mechanical junction with suitable optical properties and characteristic for coupling with the emitter or the receiver or the transmission line. According to various embodiments, each of the first waveguide coupler 170 and the second waveguide coupler 172 may be tapered or have a tapered shape.

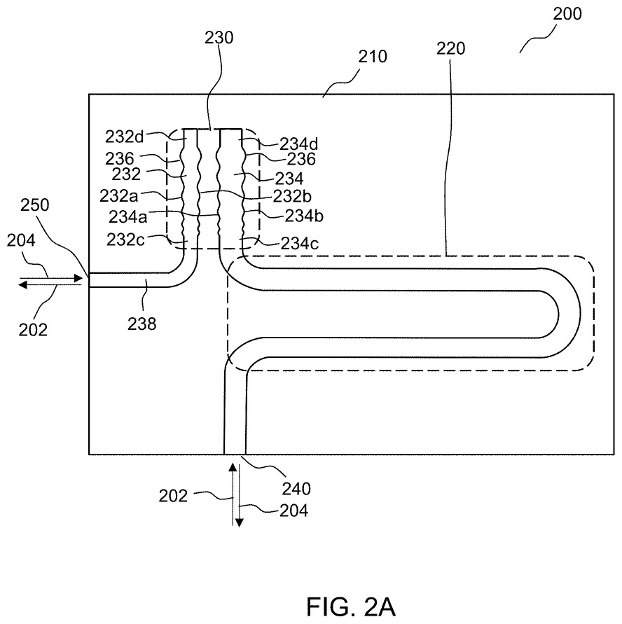

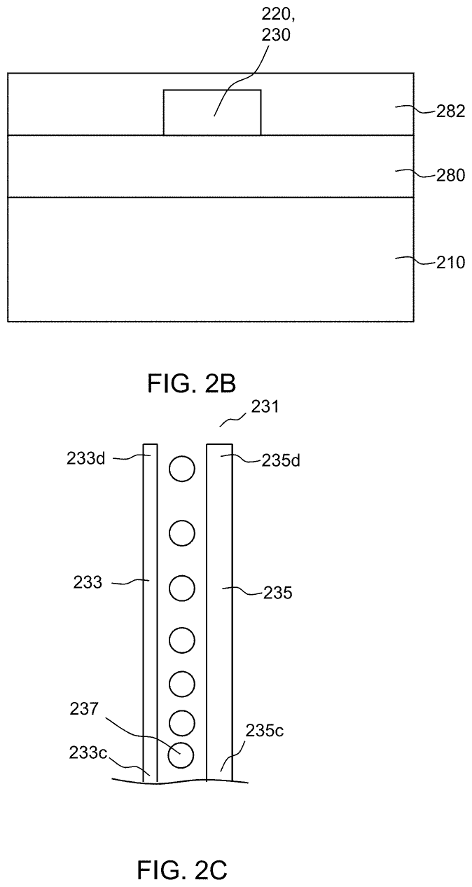

FIG. 2A shows a schematic diagram of an on-chip bidirectional pulse compressor 200 or an on-chip bidirectional optical pulse compressor according to various embodiments. According to various embodiments, the on-chip bidirectional pulse compressor 200 of FIG. 2A may contain all the features of the on-chip bidirectional pulse compressor 100, 101 of FIG. 1A and FIG. 1B. Accordingly, all features, changes, modifications, and variations that are applicable to the on-chip bidirectional pulse compressor 100, 101 of FIG. 1A and FIG. 1B may also be applicable to the on-chip bidirectional pulse compressor 200 of FIG. 2A. According to various embodiments, FIG. 2A shows a schematic diagram of a prototype of the on-chip bidirectional pulse compressor 200 according to various embodiments.

According to various embodiments, the on-chip bidirectional pulse compressor 200 may, similar to the on-chip bidirectional pulse compressor 100, 101 of FIG. 1A and FIG. 1B, be configured for temporal compression of a pulse or an optical pulse or light in a first propagation direction 102 and spectral compression of a pulse or an optical pulse or light in a second propagation direction 104. The first propagation direction 102 and the second propagation direction 104 may be opposite directions. Accordingly, the second propagation direction 104 may be reversed of the first propagation direction 102.

According to various embodiments, the on-chip bidirectional pulse compressor 200 may, similar to the on-chip bidirectional pulse compressor 100, 101 of FIG. 1A and FIG. 1B, include a substrate 210. The substrate 210 may be an underlying base or material or layer or support structure on which other materials or components may be formed or deposited. Accordingly, the substrate 210 may be the base of the on-chip system on which the pulse compressing components or circuits are integrated or formed or fabricated or embedded. With the substrate 210, the on-chip bidirectional pulse compressor 200 may be formed or built as a single integrated unitary device. According to various embodiments, the on-chip bidirectional pulse compressor 200 may include completely on-chip components with independent anomalous dispersive component and nonlinear component. According to various embodiments, the on-chip bidirectional pulse compressor 200 may have a small footprint or form factors, for example 1 mm by 0.5 μm, in contrast to the conventional fibre-based pulse compressor which is in tens of meters. Thus, the small footprint of the on-chip bidirectional pulse compressor 200 may make it easy to be used or applied in optical devices or optical system. Being an on-chip system may also enable the on-chip bidirectional pulse compressor 200 to be easily incorporated into applications that require small form factors.

According to various embodiments, the on-chip bidirectional pulse compressor 200 may, similar to the on-chip bidirectional pulse compressor 100, 101 of FIG. 1A and FIG. 1B, include a nonlinear waveguide 220 or a nonlinear optical waveguide disposed on the substrate 210. The nonlinear waveguide 220 may include a structure 222 that guides waves or pulses, such as electromagnetic waves or pulses, or optical waves or pulses, by restricting the propagation of waves or pulses to one direction along the nonlinear waveguide 220. According to various embodiments, the structure 222 of the nonlinear waveguide 120 may include a solid strip waveguide structure forming along a surface of the substrate 210. According to various embodiments, the structure 222 of the nonlinear waveguide 120 may be of a U-shaped with a pair of parallel elongated legs. According to various embodiments, the structure 222 of the nonlinear waveguide 120 may have a rectangular cross-section profile. According to various embodiments, the structure 222 of the nonlinear waveguide 120 may have a uniform cross-section throughout.

According to various embodiments, the nonlinear waveguide 220 of the on-chip bidirectional pulse compressor 200 may be dimensioned and made of a material to induce a nonlinear response within a predetermined operating wavelength ranges of the pulse or the optical pulse or the light. According to various embodiments, the nonlinear response may include, but not limited to, optical Kerr effect whereby the refractive index of the nonlinear waveguide 220 is intensity-dependent. Further, the optical Kerr effect in the nonlinear waveguide 220 may be caused by temporal variation in the intensity creating a temporal variation in the refractive index which may result in self-phase modulation (SPM) of electromagnetic or optical pulses. According to various embodiments, the nonlinear waveguide 220 may be dimensioned to optimize SPM. According to various embodiments, the nonlinear waveguide 220 may be dimensioned to minimize the number of waveguide modes and field distributions. According to various embodiments, the material of the nonlinear waveguide 220 may have a nonlinear refractive index at the predetermined operating wavelength ranges of the pulse or the optical pulse or the light as an inherent material property. According to various embodiments, the nonlinear waveguide 220 may be dimensioned to strongly confine light into a small area to cause the interaction of the optical field to have a stronger nonlinear response. Accordingly, with the combination of the material and the waveguide dimensions, the nonlinear waveguide 220 may induce the desired nonlinear response within the predetermined operating wavelength ranges of the pulse or the optical pulse or the light. According to various embodiments, in the prototype, the nonlinear waveguide 120 of the on-chip bidirectional pulse compressor 200 may have a length of 5.5 mm, a width of 450 nm and a height of 330 nm.

According to various embodiments, the predetermined operating wavelength ranges may be the desired wavelength ranges of the pulse to be compressed. According to various embodiments, in the prototype, the predetermined operating wavelength may be within the optical telecommunication wavelength ranges which range from 1260 nm to 1675 nm.

According to various embodiments, the nonlinear waveguide 220 of the on-chip bidirectional pulse compressor 200 may be made of a material free of two-photon absorption at the predetermined operating wavelength ranges of the pulse or the optical pulse or the light. Accordingly, the material of the nonlinear waveguide 220 may be free of two-photon absorption at the predetermined operating wavelength. While two-photon absorption is a nonlinear optical phenomenon that occurs when two photons are simultaneously absorbed by a material, this is an undesirable phenomenon for the nonlinear waveguide 220 in the on-chip bidirectional pulse compressor 200 according to various embodiments. According to various embodiments, temporal compression in the first propagation direction 202 of the on-chip bidirectional pulse compressor 200 and spectral compression in the second propagation direction 204 of the on-chip bidirectional pulse compressor 200 is enabled by the absence of two-photon absorption at the predetermined operating wavelength ranges in the nonlinear waveguide 220. According to various embodiments, without the two-photon absorption at the predetermined operating wavelength ranges in the nonlinear waveguide 220, the nonlinear waveguide 220 may have low nonlinear losses to provide the necessary conditions for achieving temporal compression in the first propagation direction 202 of the on-chip bidirectional pulse compressor 200 and spectral compression in the second propagation direction 204 of the on-chip bidirectional pulse compressor 200. According to various embodiments, the material free of two-photon absorption may include a material having minimal or negligible two-photon absorption at the predetermined operating wavelength ranges of the pulse or the optical pulse or the light. According to various embodiments, the material having minimal or negligible two-photon absorption may have a low two-photon absorption coefficient. According to various embodiments, the low two-photon absorption coefficient may result in a large nonlinear figure of merit (FOM) as defined earlier, wherein the FOM may be at least 4.5 at the predetermined operating wavelength ranges of the pulse or the optical pulse or the light.

According to various embodiments, the material of the nonlinear waveguide 220 of the on-chip bidirectional pulse compressor 200 may be complementary metal oxide semiconductor (CMOS) compatible. Accordingly, the material of the nonlinear waveguide 220 may enable it to be fabricated using the manufacturing processes used for silicon electronics. According to various embodiments, the CMOS compatible material free of two-photon absorption within the optical telecommunication wavelength ranges for the nonlinear waveguide 220 of the on-chip bidirectional pulse compressor 200 may include ultra-silicon-rich nitride (USRN).

According to various embodiments, gallium arsenide (GaAs), aluminium gallium arsenide (AlGaAs) are not CMOS compatible material. Thus, these materials were not used in the prototype. According to various embodiments, materials such as silicon (Si) cannot be used because it has high nonlinear loss, in particular high two-photon absorption within these wavelength, which would not allow spectral compression to be achieved in the manner of the on-chip bidirectional pulse compressor 200 of the various embodiments. This is because, when there is high nonlinear losses, the required nonlinear phase for compression cannot be acquired and, hence, spectral compression may not be achievable. The high nonlinear loss will also limit the temporal compression and, hence, lead to ineffective temporal compression. Thus, most of the commonly used optical waveguides, which are made from silicon (Si) may not be suitable to achieve the bidirectional compression in the manner of the on-chip bidirectional pulse compressor 200 of the various embodiments.

According to various embodiments, the USRN material may include amorphous, polycrystalline or crystalline material that contains both silicon (Si) and nitrogen (Ni). Further, in the USRN material, a quantity of the silicon (Si) is higher than stoichiometric silicon nitride (Si₃N₄). Accordingly, the quantitative relationships or ratios between silicon (Si) and nitrogen (Ni) in the USRN material is higher than that of stoichiometric silicon nitride (Si₃N₄).

According to various embodiments, the on-chip bidirectional pulse compressor 200 may, similar to the on-chip bidirectional pulse compressor 100, 101 of FIG. 1A and FIG. 1B, include an anomalous dispersive component 230 disposed on the substrate 210. According to various embodiments, the anomalous dispersive component 230 may induce a differential group delay with respect to wavelength experienced by a field to induce dispersion of the pulse or the optical pulse or the light. According to various embodiments, in the anomalous dispersive component 230, the differential group delay may decrease with increasing frequency (or decreasing wavelength) component within the predetermined operating wavelength ranges of the pulse or the optical pulse or the light to induce anomalous dispersion of the pulse or the optical pulse or the light.

According to various embodiments, the anomalous dispersive component 230 of the on-chip bidirectional pulse compressor 200 may be configured to induce anomalous dispersion based on a linear relationship between the differential group delay and the frequency (or wavelength) component within the predetermined wavelength ranges. According to various embodiments, the anomalous dispersive component 230 may be configured such that the differential group delay may decrease linearly with increasing frequency (or decreasing wavelength) components within the predetermined operating wavelength ranges. Accordingly, when the pulse or the optical pulse or the light propagates through the anomalous dispersive component 230, higher frequency (or shorter wavelength) components may experience less delay and advance faster in time relative to lower frequency (or longer wavelength) components.

According to various embodiments, the anomalous dispersive component 230 of the on-chip bidirectional pulse compressor 200 may include a pair of parallel solid elongated strip structures 232, 234. Accordingly, the anomalous dispersive component 230 may include a first solid elongated strip structure 232 and a second solid elongate strip structure 234 arranged parallel to each other. According to various embodiments, each of the pair of parallel solid elongated strip structures 232, 234 may include two sinusoidally corrugated longitudinal sidewalls 232a, 232b, 234a, 234b. Accordingly, the two sinusoidally corrugated longitudinal sidewalls 232a, 232b, 234a, 234b may be on corresponding longitudinal sides of each solid elongate strip structures 232, 234. According to various embodiments, each of the corrugated longitudinal sidewalls 232a, 232b, 234a, 234b may include alternating parallel ridges or grooves forming corrugations 236 with sinusoidal profile along the corresponding longitudinal sidewalls 232a, 232b, 234a, 234b of each solid elongate strip structures 232, 234.

According to various embodiments, a corrugation period of each longitudinal sidewall 232a, 232b, 234a, 234b may vary linearly lengthwise from a first longitudinal end 232c, 234c to a second longitudinal end 232d, 234d of each solid elongate strip structures 232, 234. According to various embodiments, the corrugation period of each longitudinal sidewall 232a, 232b, 234a, 234b may increase linearly lengthwise from the first longitudinal end 232c, 234c to the second longitudinal end 232d, 234d of each solid elongate strip structures 232, 234. Accordingly, a width of each corrugation 236 of each longitudinal sidewall 232a, 232b, 234a, 234b may increase linearly starting from the first corrugation closest to the first longitudinal end 232c, 234c of each solid elongate strip structures 232, 234 lengthwise to the last corrugation towards the second longitudinal end 232d, 234d of each solid elongate strip structures 232, 234. According to various embodiments, a length of each solid elongate strip structures 232, 234 may be 0.5 mm.

According to various embodiments, each solid elongate strip structure 232, 234 may have mirror symmetry about its longitudinal axis. Accordingly, the two sinusoidally corrugated longitudinal sidewalls 232a, 232b, 234a, 234b of each solid elongate strip structure 232, 234 may be mirror image of each other. According to various embodiments a width of the second solid elongate strip structure 234 may be wider than a width of the first solid elongate strip structure 232. According to various embodiments the first solid elongate strip structure 232 and the second solid elongate strip structure 234 may be spaced laterally apart from each other.

According to various embodiments, the first longitudinal end 232c of the first solid elongate strip structure 232 may be integral with an extension 238 extending to an input/output interface 250 of the on-chip bidirectional pulse compressor 200 and the first longitudinal end 234c of the second solid elongate strip structure 234 may be integral with the nonlinear waveguide 220. Accordingly, the first solid elongate strip structure 232 of the anomalous dispersive component 230 and the extension 238 may be a single continuous structure, and the second solid elongate strip structure 234 of the anomalous dispersive component 230 and the nonlinear waveguide 220 may be a single continuous structure.

According to various embodiments, the anomalous dispersive component 230 of the on-chip bidirectional pulse compressor 200 may be made of the same material as the nonlinear waveguide 220 of the on-chip bidirectional pulse compressor 200. According to various embodiments, at least a part of the anomalous dispersive component 230 and the nonlinear waveguide 220 may be integrally formed on the substrate in a manner so as to form a continuous monolithic structure. For example, the second solid elongate strip structure 234 and the nonlinear waveguide 220 may be integrally formed on the substrate. According to various embodiments, the anomalous dispersive component 230 and the nonlinear waveguide 220 may be made of the same USRN material. According to various embodiments, the continuity between the nonlinear waveguide 220 and part of the anomalous dispersive component 230 as a continuous monolithic structure may bring about low loss, compactness and ease of manufacturing.

According to various embodiments, the anomalous dispersive component 230 of the on-chip bidirectional pulse compressor 200 may be configured to induce anomalous dispersion during transmission or propagation of the pulse or the optical pulse or the light through the anomalous dispersive component 230 and not via reflection. Thus, the on-chip bidirectional pulse compressor 200 may not require additional component, such as an optical circulator, for rerouting of the pulse or the optical pulse or the light. Accordingly, the on-chip bidirectional pulse compressor 200 may be free of or without the optical circulator for rerouting the pulse or the optical pulse or the light to and/or from the anomalous dispersive component 230.

According to various embodiments, in operation, the pulse or the optical pulse or the light may be propagated through the on-chip bidirectional pulse compressor 200, similar to the on-chip bidirectional pulse compressor 100, 101 of FIG. 1A and FIG. 1B, in the first propagation direction 202 for temporal compression of the pulse or the optical pulse or the light, and the pulse or the optical pulse or the light may be propagated through the on-chip bidirectional pulse compressor 200, similar to the on-chip bidirectional pulse compressor 100, 101 of FIG. 1A and FIG. 1B, in the second propagation direction 204 for spectral compression of the pulse or the optical pulse or the light. According to various embodiments, when the pulse or the optical pulse or the light is propagating in the first propagation direction 202, the pulse or the optical pulse or the light may propagate through the components of the on-chip bidirectional pulse compressor 200 in the order or sequence of the nonlinear waveguide 220 followed by the anomalous dispersive component 230. According to various embodiments, when the pulse or the optical pulse or the light is propagating in the second propagation direction 204, the pulse or the optical pulse or the light may propagate through the components of the on-chip bidirectional pulse compressor 200 in the order or sequence of the anomalous dispersive component 230 followed by the nonlinear waveguide 220.

According to various embodiments, when the pulse or the optical pulse or the light propagates in the first propagation direction 202 through the nonlinear waveguide 220 followed by the anomalous dispersive component 230, the nonlinear waveguide 220 may induce self-phase modulation on the pulse or the optical pulse or the light to broaden a spectrum of the pulse or the optical pulse or the light so as to increase the frequency (or wavelength) components of the pulse or the optical pulse or the light. During the self-phase modulation, the pulse or the optical pulse or the light may undergo a phase shift to broaden the spectrum of the pulse or the optical pulse or the light. Subsequently, the anomalous dispersive component 230 may induce anomalous dispersion to temporally shift the frequency (or wavelength) components of the broadened spectrum towards a centre of the pulse in a manner so as to cause temporal compression of the pulse or the optical pulse or the light. During anomalous dispersion, the linearly varied differential group delay may cause higher frequency (or shorter wavelength) components to temporally move faster due to less time delay and lower frequency (or longer wavelength) components to temporally move slower due to more time delay resulting in temporal compression of the pulse or the optical pulse or the light.

According to various embodiments, when the pulse or the optical pulse or the light propagates in the second propagation direction through the anomalous dispersive component 230 followed by the nonlinear waveguide 220, the anomalous dispersive component 230 may induce anomalous dispersion on the pulse to temporally shift the frequency (or wavelength) components of a spectrum of the pulse such that higher frequency (or shorter wavelength) components of the spectrum advance ahead in time relative to lower frequency (or longer wavelength) components of the spectrum. During anomalous dispersion, the linearly varied differential group delay may cause a linear frequency chirp whereby higher frequency (or shorter wavelength) components may temporally move faster due to less time delay and lower frequency (or longer wavelength) components may temporally move slower due to more time delay resulting in an anomalous dispersion or a reverse of the normal dispersion of the pulse or the optical pulse or the light. Subsequently, the nonlinear waveguide 220 may induce self-phase modulation to redshift (or upshift) the higher frequency (or shorter wavelength) components of the spectrum which are leading and blueshift (or downshift) the lower frequency (or longer wavelength) components of the spectrum which are trailing in a manner so as to cause spectral compression of the pulse or the optical pulse or the light. During the self-phase modulation, the pulse or the optical pulse or the light may undergo a phase shift to redshift (or upshift) the leading frequency (or wavelength) components, i.e. frequency components that are temporally faster, and blueshift (or downshift) the trailing frequency (or wavelength) components, i.e. frequency components that are temporally slower. Since the leading frequency (or wavelength) components are the higher frequency (or shorter wavelength) components of the spectrum and the trailing frequency (or wavelength) components are the lower frequency (or longer wavelength) components of the spectrum, the phase shift due to self-phase modulation causes the frequency (or wavelength) components of the spectrum to shift towards a centre of the spectrum to result in spectral compression.

According to various embodiments, a degree of spectral compression and/or temporal compression of the on-chip bidirectional pulse compressor 200 may be varied or controlled via configuring the nonlinear waveguide 220 and/or the anomalous dispersive component 230. Accordingly, a desired degree of spectral compression and temporal compression to be achieved by the on-chip bidirectional pulse compressor 200 may be achieved by varying or adjusting a configuration of the nonlinear waveguide 220 and the anomalous dispersive component 230.

According to various embodiments, the on-chip bidirectional pulse compressor 200 may include a first input/output interface 240 associated with the nonlinear waveguide 220 and the second input/output interface 250 associated with the anomalous dispersive component 230. Accordingly, the first input/output interface 240 and the nonlinear waveguide 220 are in a one-to-one relationship whereby any pulse or optical pulse or light may transmit directly between the first input/output interface 240 and the nonlinear waveguide 220. Similarly, the second input/output interface 250 and the anomalous dispersive component 230 are in a one-to-one relationship whereby any pulse or optical pulse or light may transmit directly between the second input/output interface 250 and the anomalous dispersive component 230. According to various embodiments, each of the first input/output interface 240 and the second input/output interface 250 may be configured to serve and function as both input and output. According to various embodiments, when the on-chip bidirectional pulse compressor 200 is used for temporal compression in the first propagation direction 202, the first input/output interface 240 may serve as an input interface for receiving the pulse or the optical pulse or the light, and the second input/output interface 250 may serve as an output interface to output the temporally compressed pulse or optical pulse or light. According to various embodiments, when the on-chip bidirectional pulse compressor 200 is used for spectral compression in the second propagation direction 204, the second input/output interface 250 may serve as an input interface for receiving the pulse or the optical pulse or the light, and the first input/output interface 240 may serve as an output interface to output the spectrally compressed pulse or optical pulse or light. According to various embodiments, the on-chip bidirectional pulse compressor 200 may include only two input/output interface 250, i.e. the first input/output interface 240 and the second input/output interface 250.

According to various embodiments, the on-chip bidirectional pulse compressor 200, may similar to the on-chip bidirectional pulse compressor 101 of FIG. 1B, further include a first waveguide coupler (not shown) coupled to the first input/output interface 240 associated with the nonlinear waveguide 220 and a second waveguide coupler (not shown) coupled to the second input/output interface 250 associated with the anomalous dispersive component 230. According to various other embodiments, the on-chip bidirectional pulse compressor 200, may similar to the on-chip bidirectional pulse compressor 101 of FIG. 1B, further include a thermo-optic tuning component (not shown) coupled to the anomalous dispersive component 230 for active control of the anomalous dispersion.

FIG. 2B shows a layered arrangement of the on-chip bidirectional pulse compressor 200 according to various embodiments. As shown, the substrate 210 may form the base of the on-chip bidirectional pulse compressor 200. According to various embodiments, the on-chip bidirectional pulse compressor 200 may include an under-cladding layer 280 formed on the substrate 210. According to various embodiments, the nonlinear waveguide 220 and the anomalous dispersive component 230 of the on-chip bidirectional pulse compressor 200 may be formed on the under-cladding layer 280. According to various embodiments, the on-chip bidirectional pulse compressor 200 may further include an upper-cladding layer 282 formed over the nonlinear waveguide 220 and the anomalous dispersive component 230 so as to encapsulate the nonlinear waveguide 220 and the anomalous dispersive component 230. According to various embodiments, the under-cladding layer 280 and the upper-cladding layer 282 may provide optical confinement of the mode and/or modal symmetry. Further, the upper-cladding layer 282 may also provide mechanical robustness to the on-chip bidirectional pulse compressor 200. Accordingly, the under-cladding layer 280 and the upper-cladding layer 282 may serve to protect the nonlinear waveguide 220 and the anomalous dispersive component 230. According to various embodiments, the under-cladding layer 280 and the upper-cladding layer 282 may be optional. According to various embodiments, the on-chip bidirectional pulse compressor 200 may be without the under-cladding layer 280 and the upper-cladding layer 282.

According to various embodiments, the substrate 210 may be made of silicon. Accordingly, the substrate 210 may be a silicon substrate. According to various embodiments, the under-cladding layer 280 may be made of silicon dioxide (SiO₂). According to various embodiments, the upper-cladding layer 282 may also be made of silicon dioxide (SiO₂). According to various embodiments, a thickness of the substrate 210 may be at least 600 μm. According to various embodiments, a thickness of the under-cladding layer 280 may be between 100 nm to 100 μm, or preferably 500 nm to 50 μm, or preferably between 1 μm to 10 μm. According to various embodiments, a thickness of the upper-cladding layer 282 may be between 100 nm to 100 μm, or preferably 500 nm to 50 μm, or preferably between 1 μm to 10 μm. According to various embodiments, in the prototype of the on-chip bidirectional pulse compressor 200, the under-cladding layer 280 has a thickness of 2 μm and the upper-cladding layer 282 has a thickness of 3 μm.

FIG. 2C shows a variant of an anomalous dispersive component 231 for the on-chip bidirectional pulse compressor 200 according to various embodiments. According to various embodiments, the anomalous dispersive component 231 of FIG. 2C may replace or substitute the anomalous dispersive component 230 of FIG. 2A. According to various embodiments, the anomalous dispersive component 231 may include a pair of parallel solid elongated strip structures 233, 235. Accordingly, the anomalous dispersive component 230 may include a first solid elongated strip structure 233 and a second solid elongate strip structure 235 arranged parallel to each other. According to various embodiments, the anomalous dispersive component 231 may further include a row of circular structures 237 between the pair of parallel solid elongated strip structures 233, 235. According to various embodiments, the row of circular structures 237 may be aligned longitudinally with respect to the pair of parallel solid elongated strip structures 233, 235. According to various embodiments, the pair of parallel solid elongated strip structure 233, 235 and the row of circular structures 237 may be made of the same materials.

According to various embodiments, a distance apart between two adjacent circular structures 237 along the row of circular structures 237 may vary linearly in a direction parallel to the solid elongated strip structures 233, 235. According to various embodiments, the distance apart between two adjacent circular structures 237 along the row of circular structures 237 may increase linearly in the direction from a first longitudinal end 233c, 235c to a second longitudinal end 233d, 235d of each solid elongate strip structures 233, 235. According to various embodiments, a length of each solid elongate strip structures 233, 235 may be 0.5 mm.

According to various embodiments a width of the second solid elongate strip structure 235 may be wider than a width of the first solid elongate strip structure 233. According to various embodiments the first solid elongate strip structure 233 and the second solid elongate strip structure 235 may be spaced laterally apart from each other.

According to various embodiments, when the anomalous dispersive component 231 is integrated into the on-chip bidirectional pulse compressor 200, the first longitudinal end 233c of the first solid elongate strip structure 233 may be integral with the extension 238 extending to an input/output interface 250 of the on-chip bidirectional pulse compressor 200 and the first longitudinal end 235c of the second solid elongate strip structure 235 may be integral with the nonlinear waveguide 220. Accordingly, the first solid elongate strip structure 233 of the anomalous dispersive component 231 and the extension 238 may be a single continuous structure, and the second solid elongate strip structure 235 of the anomalous dispersive component 230 and the nonlinear waveguide 220 may be a single continuous structure.

According to various embodiments, when integrated into the on-chip bidirectional pulse compressor 200, the anomalous dispersive component 231 may be made of the same material as the nonlinear waveguide 220 of the on-chip bidirectional pulse compressor 200. According to various embodiments, at least a part of the anomalous dispersive component 231 and the nonlinear waveguide 220 may be integrally formed on the substrate in a manner so as to form a continuous monolithic structure. For example, the second solid elongate strip structure 235 of the anomalous dispersive component 231 and the nonlinear waveguide 220 may be integrally formed on the substrate. According to various embodiments, the anomalous dispersive component 231 and the nonlinear waveguide 220 may be made of the same USRN material. According to various embodiments, the continuity between the nonlinear waveguide 220 and part of the anomalous dispersive component 231 as a continuous monolithic structure may bring about low loss, compactness and ease of manufacturing.

In the following, experimental results demonstrating temporal and spectral compression achieved in the prototype of the on-chip bidirectional pulse compressor 200 according to various embodiments are presented. According to various embodiments, the on-chip bidirectional pulse compressor 200 may be a two-stage, nonlinear ultra-silicon-rich nitride (USRN) system including the nonlinear waveguide 220 and the anomalously dispersive component 230. According to various embodiments, in the prototype of the on-chip bidirectional pulse compressor 200, the nonlinear waveguide 220 was implemented in the form of a nonlinear CMOS-compatible USRN photonic nanowire waveguide. According to various embodiments, the experimental results show that the on-chip bidirectional pulse compressor 200 in the form of a two-stage compression system may be used with inputs and outputs reversed to create both temporal and spectral compression. The results shows that self-phase modulation induced spectral broadening generated by the nonlinear waveguide 220 may be re-phased using the anomalously dispersive component 230 to generate 4.3× compression of 5.6 ps pulses. The results also show that when the on-chip bidirectional pulse compressor 200 in the form of a two-stage compression system is used with the anomalously dispersive component 230 as the first stage and nonlinear waveguide 220 as the second stage, pulses first undergo a temporal delay in the spectral components, before being re-phased by the frequency chirp introduced by the nonlinear waveguide 220 to achieve 2.3× spectral compression of 350 fs pulses.

In the temporal compression experiments performed, a fibre laser emitting 5.6 ps pulses centred at 1550 nm, with a 20 MHz repetition rate was used. An Erbium-Doped Fibre Amplifier (EDFA) was used to increase the pulse peak power. The quasi-transverse electric (TE) optical pulses was then input to the on-chip bidirectional pulse compressor 200.

Accordingly, the quasi-TE optical pulses passed through the nonlinear waveguide 220, which was a 5.5-mm long USRN nanowire waveguide with a width of 330 nm and height of 450 nm. These pulses underwent self-phase modulation through the nonlinear waveguide 220 followed by anomalous dispersion through the anomalous dispersive component 230. The anomalous dispersive component 230 was in the form of an anomalously dispersive grating with length of 0.5 mm, which includes two coupled sinusoidally corrugated gratings (or the pair of parallel solid elongate strip structures 232, 234) with positive linear chirp for frequency chirp compensation. The output pulse from the on-chip bidirectional pulse compressor 200 after the anomalous dispersive component 230 was coupled to an optical analyser and auto-correlator to measure spectra and temporal traces, respectively.

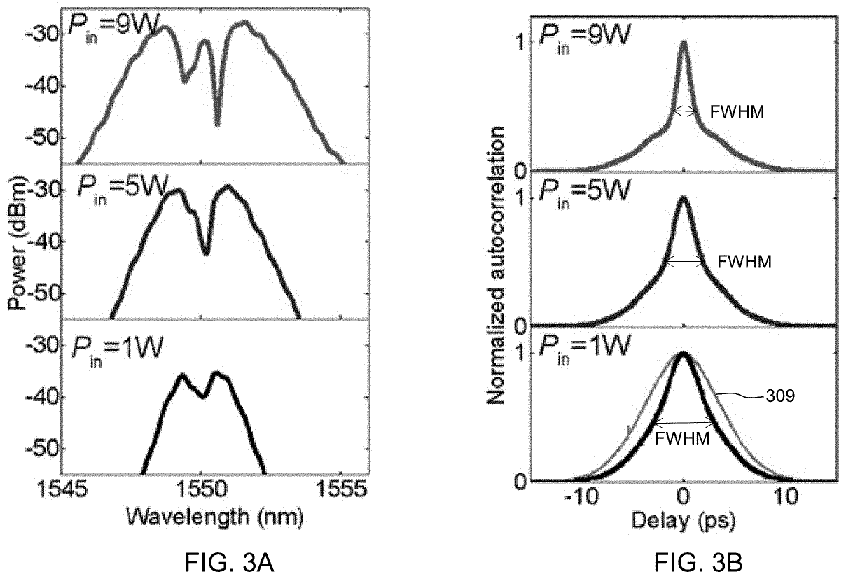

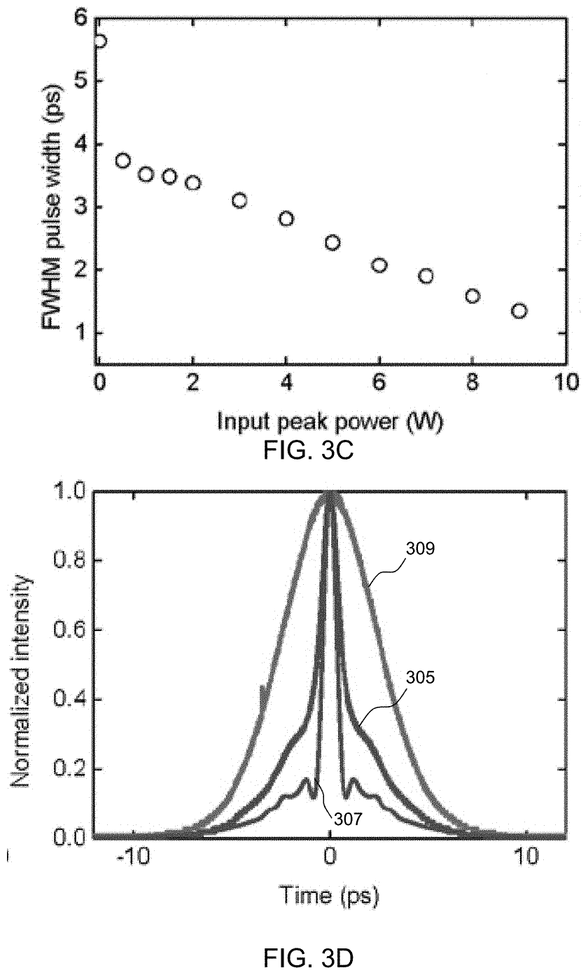

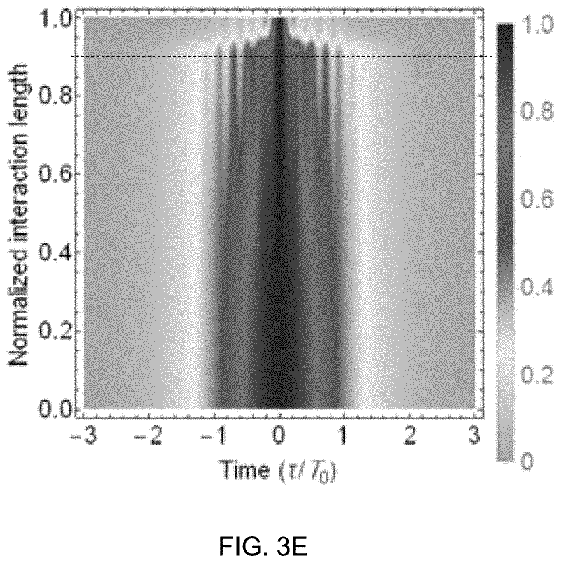

The measured output spectra and temporal pulses are shown in FIG. 3A and FIG. 3B respectively. The line 309 in FIG. 3B shows the input pulse. As the pulse peak power increases, the output underwent increasing self-phase modulation induced spectral broadening at the nonlinear waveguide 220. At the maximum coupled peak power (Pin), the output spectrum broadened to a 3 dB bandwidth of 4 nm, 2.2× that of the input pulse bandwidth. The measured output pulse FWHM (full width at half maximum) is as a function of Pin as shown in FIG. 3B and FIG. 3C, indicating the decrease in pulse width as Pin increases. The anomalous dispersive component 230 placed after the nonlinear waveguide 220 then temporally compressed the pulse. The experimental results show that the compressed temporal pulse to be compressed from 5.6 ps input down to 1.4 ps at the maximum Pin=9 W. Accordingly, the compression factor (Fc), defined as the ratio of the pulse width at FWHM of the input pulse to that of the compressed pulse, is obtained to be 4.3.

Modelling using the nonlinear Schrödinger equation was also performed. FIG. 3D shows the measured and theoretical temporal pulses being plotted along with input pulse at Pin=9 W. The line 307 in FIG. 3D shows the output pulses at Pin=9 W based on modelling. The line 305 in FIG. 3D shows the experimental output pulses at Pin=9 W. The line 309 in FIG. 3D shows the input pulses. As shown, the width of the theoretical pulse (as shown by line 307) is estimated to ˜1 ps, which agrees well with the FWHM of the experimental pulse (as shown by line 305). FIG. 3E shows the calculated temporal pulse evolution as a function of the normalized interaction length. To is defined as input pulse width/1.76. Significant temporal compression occurs when the normalized interaction length exceeds 0.9 whereby the frequency chirp from self-phase modulation in the nonlinear waveguide 220 is optimally matched by the anomalous dispersion in the anomalous dispersive component 230.

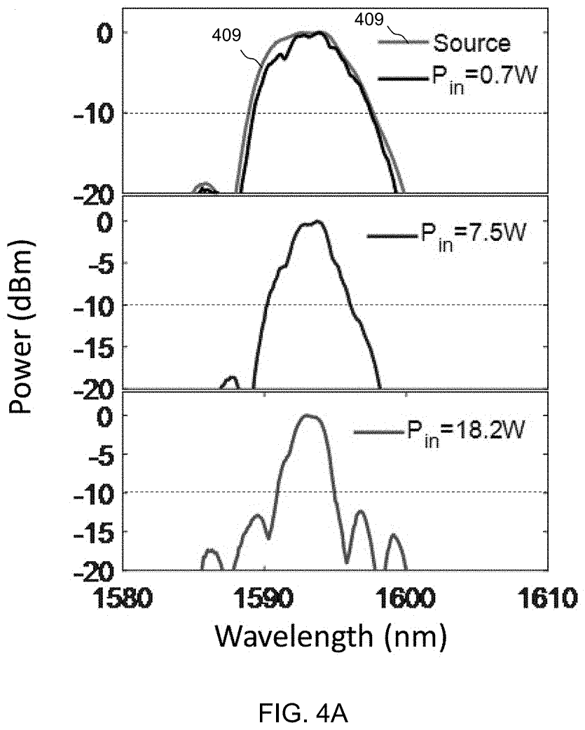

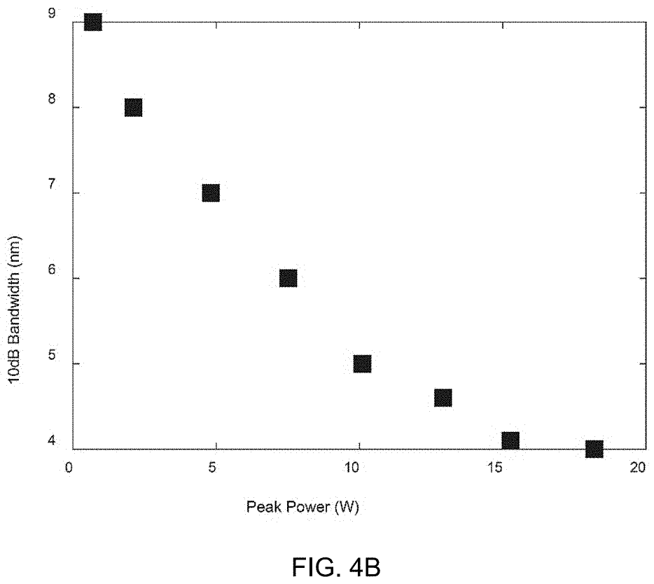

In the spectral compression experiments performed, 480 fs pulses centred at 1593 nm were launched into the anomalous dispersive component 230 as the first stage before they were propagated into the nonlinear waveguide 220, i.e. the USRN waveguide. In this sequence, the anomalous dispersion in the anomalous dispersive component 230 may cause the longer wavelength (or lower frequency) components to be delayed relative to the shorter wavelength (or higher frequency) components. The nonlinear waveguide 220 in the second stage may then impart an equilibrating effect to approach a pulse that is spectrally narrower. FIG. 4A shows measured pulse spectrum as the peak input power is increased. As shown, the pulses are spectrally compressed when launched first into the anomalous dispersive component 230. Line 409 in FIG. 4A shows the input pulses. FIG. 4B shows 10 dB bandwidth of spectrally compressed pulses as the input pulse peak power is increased. As shown, the 10 dB bandwidth of the pulses are observed to decrease as peak power is increased. The pulses are observed to have a maximum spectral compression of 2.3.

From the above, a two-stage system based on USRN, such as the on-chip bidirectional pulse compressor 200 according to various embodiments, is demonstrated to achieve nonlinear spectral and temporal compression. According to various embodiments, the on-chip bidirectional pulse compressor 200 may be used interchangeably with input and output reversed to create the nonlinear phase profile and resynchronization of all spectral elements to generate both spectral and temporal compression. Further, the spectral and temporal compression factors of 2.3 and 4.3 experimentally achieved above demonstrated potential for the on-chip bidirectional pulse compressor 200 of the various embodiments to be highly useful for tailored optical pulse delivery in optical signal processing, imaging and telecommunications applications.

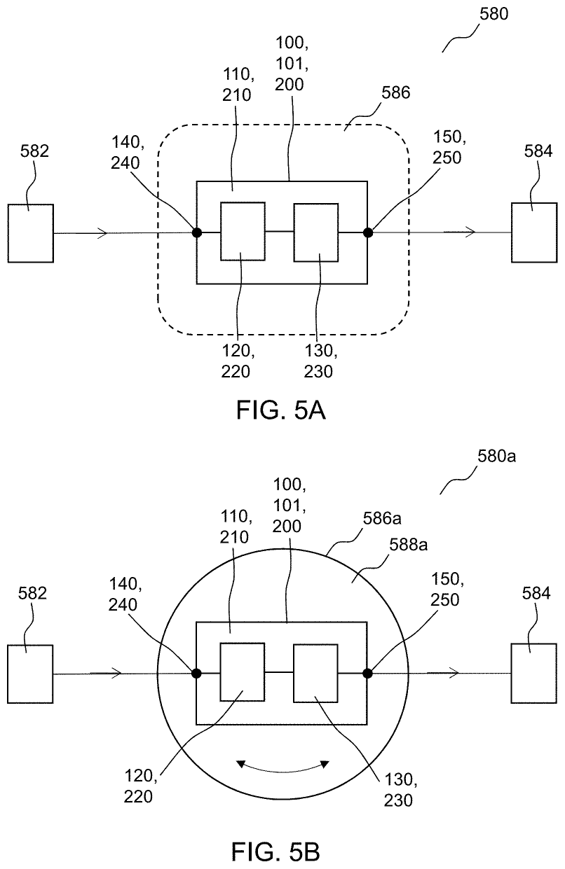

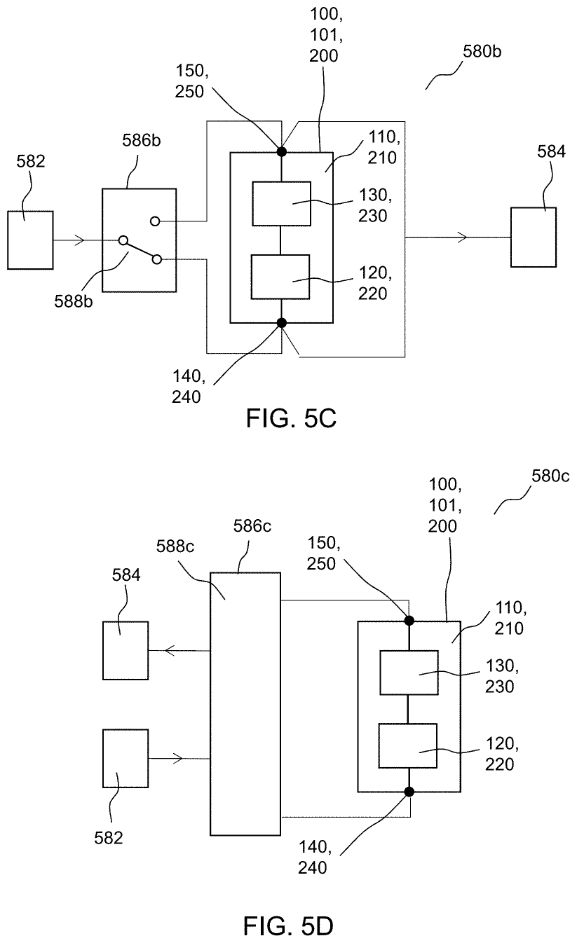

FIG. 5A shows an optical system 580 including the on-chip bidirectional pulse compressor 100, 101, 200 according to various embodiments. As shown, the optical system 580 may include a pulse emitter 582 or an optical pulse emitter operable to emit a pulse or an optical pulse within a predetermined operating wavelength. According to various embodiments, the predetermined operating wavelength may be within the optical telecommunication wavelength ranges which range from 1260 nm to 1675 nm. According to various embodiments, the optical system 580 may include a pulse receiver 584 for receiving a compressed pulse or compressed optical pulse.

According to various embodiments, the on-chip bidirectional pulse compressor 100, 101, 200 of FIG. 1A, FIG. 1B and FIG. 2A may be disposed along a transmission path between the pulse emitter 582 and the pulse receiver 584. According to various embodiments, the on-chip bidirectional pulse compressor 100, 101, 200 may include the substrate 110, 210, the nonlinear waveguide 120, 220, the anomalous dispersive component 130, 230, the first input/output interface 140, 240, and the second input/output interface 150, 250 as described previously.

According to various embodiments, optical system 504 may include a transmission path switching mechanism 586 configured to switch between a first transmission path and a second transmission path.

According to various embodiments, in the first transmission path, the pulse emitter 582 may emit the pulse or the optical pulse to the first input/output interface 140, 240 for propagating the pulse or the optical pulse through the on-chip bidirectional pulse compressor 100, 101, 200 in the first propagation direction 102, 202 through the nonlinear waveguide 120, 220 followed by the anomalous dispersive component 130, 230. Accordingly, the nonlinear waveguide 120, 220 may induce self-phase modulation on the pulse or the optical pulse to broaden the spectrum of the pulse or the optical pulse. During the self-phase modulation, the pulse or the optical pulse or the light may undergo a phase shift to broaden the spectrum of the pulse or the optical pulse. Subsequently, the anomalous dispersive element 130, 230 may induce anomalous dispersion to temporally shift the frequency (or wavelength) components of the broadened spectrum towards a centre of the pulse or the optical pulse. During anomalous dispersion, the linearly varied differential group delay may cause higher frequency (or shorter wavelength) components to temporally move faster due to less time delay and lower frequency (or longer wavelength) components to temporally move slower due to more time delay resulting in temporal compression of the pulse or the optical pulse. Thus, via the first transmission path, the on-chip bidirectional pulse compressor 100, 101, 200 may output a temporally compressed pulse or optical pulse from the second input/output interface 150, 250 to the pulse receiver 584.

According to various embodiments, in the second transmission path, the pulse emitter 582 may emit the pulse or the optical pulse to the second input/output interface 150, 250 for propagating the pulse or the optical pulse through the on-chip bidirectional pulse compressor 100, 101, 200 in the second propagation direction 104, 204 through the anomalous dispersive component 130, 230 followed by the nonlinear waveguide 120, 220. Accordingly, the anomalous dispersive component 130, 230 may induce anomalous dispersion on the pulse or the optical pulse to temporally shift frequency (or wavelength) components of a spectrum of the pulse or the optical pulse such that higher frequency (or shorter wavelength) components of the spectrum advance ahead relative to lower frequency (or longer wavelength) components of the spectrum. During anomalous dispersion, the linearly varied differential group delay may cause a linear frequency chirp whereby higher frequency (or shorter wavelength) components may temporally move faster due to less time delay and lower frequency (or longer wavelength) components may temporally move slower due to more time delay resulting in an anomalous dispersion or a reverse of the normal dispersion of the pulse or the optical pulse. Subsequently, the nonlinear waveguide 120, 220 may induce self-phase modulation to redshift (or upshift) the higher frequency (or shorter wavelength) components of the spectrum which are leading and blueshift (or downshift) the lower frequency (or longer wavelength) components of the spectrum which are trailing. During the self-phase modulation, the pulse or the optical pulse or the light may undergo a phase shift to redshift (or upshift) the leading frequency (or wavelength) components, i.e. frequency components that are temporally faster, and blueshift (or downshift) the trailing frequency (or wavelength) components, i.e. frequency components that are temporally slower. Since the leading frequency (or wavelength) components are the higher frequency (or shorter wavelength) components of the spectrum and the trailing frequency (or wavelength) components are the lower frequency (or longer wavelength) components of the spectrum, the phase shift due to self-phase modulation causes the frequency (or wavelength) components of the spectrum to shift towards a centre of the spectrum to result in spectral compression. Thus, via the second transmission path, the on-chip bidirectional pulse compressor 100, 101, 200 may output a spectrally compressed pulse from the first input/output interface 140, 240 to the pulse receiver 584.

According to various embodiments, the transmission path switching mechanism 586 may include a mechanical switching mechanism 586a, 586b or an electronic switching mechanism 586c.

FIG. 5B shows an optical system 580a including the on-chip bidirectional pulse compressor 100, 101, 200 with the mechanical switching mechanism 586a according to various embodiments. According to various embodiments, the mechanical switching mechanism 586a may include a rotatable stage 588a on which the on-chip bidirectional pulse compressor 100, 101, 200 may be mounted. According to various embodiments, the rotatable stage 588a of the mechanical switching mechanism 586a may be rotated so as to rotate the on-chip bidirectional pulse compressor 100, 101, 200 in a manner so as to switch between the first transmission path and the second transmission path. In the first transmission path, the rotatable stage 588a of the mechanical switching mechanism 586a may be rotated so as to connect the pulse emitter 582 to the first input/output interface 140, 240 of the on-chip bidirectional pulse compressor 100, 101, 200 and connect the second input/output interface 150, 250 of the on-chip bidirectional pulse compressor 100, 101, 200 to the pulse receiver 584 (for example as shown in FIG. 5B). In the second transmission path, the rotatable stage 588a of the mechanical switching mechanism 586a may be rotated so as to connect the pulse emitter 582 to the second input/output interface 150, 250 of the on-chip bidirectional pulse compressor 100, 101, 200 and connect the first input/output interface 140, 240 of the on-chip bidirectional pulse compressor 100, 101, 200 to the pulse receiver 584.

FIG. 5C shows an optical system 580b including the on-chip bidirectional pulse compressor 100, 101, 200 with the mechanical switching mechanism 586b according to various embodiments. According to various embodiments, the mechanical switching mechanism 586b may include a toggle-type switch 588b that physically shift optical wires for alternate routing between the first transmission path and the second transmission path. In the optical system 580b, the pulse emitter 582 may be connected to the toggle-type switch 588b, the toggle-type switch 588b may be connected to both the first input/output interface 140, 240 and the second input/output interface 150, 250 of the on-chip bidirectional pulse compressor 100, 101, 200, and the pulse receiver 584 may be connected to both the first input/output interface 140, 240 and the second input/output interface 150, 250 of the on-chip bidirectional pulse compressor 100, 101, 200. Accordingly, when routing along the first transmission path is required, the toggle-type switch 588b may be switched to route the pulse emitter 582 to the first input/output interface 140, 240 of the on-chip bidirectional pulse compressor 100, 101, 200 such that the pulse or the optical pulse emitted from the pulse emitter 582 may be input to the on-chip bidirectional pulse compressor 100, 101, 200 via the first input/output interface 140, 240 and the compressed pulse may be output from the second input/output interface 150, 250 of the on-chip bidirectional pulse compressor 100, 101, 200 to the pulse receiver 584. When routing along the second transmission path is required, the toggle-type switch 588b may be switched to route the pulse emitter 582 to the second input/output interface 150, 250 of the on-chip bidirectional pulse compressor 100, 101, 200 such that the pulse or the optical pulse emitted from the pulse emitter 582 may be input to the on-chip bidirectional pulse compressor 100, 101, 200 via the second input/output interface 150, 250 and the compressed pulse may be output from the first input/output interface 140, 240 of the on-chip bidirectional pulse compressor 100, 101, 200 to the pulse receiver 584.

According to various embodiments, the transmission path switching mechanism 586 may include a mechanical switching mechanism (not shown) configured for physically connecting the optical wire/fibres from the pulse emitter 582 to either the first input/output interface 140, 240 or the second input/output interface 150, 250 of the on-chip bidirectional pulse compressor 100, 101, 200 and the optical wire/fibres to the pulse receiver 584 accordingly so as to switch between the first transmission path and the second transmission path.

FIG. 5D shows an optical system 580c including the on-chip bidirectional pulse compressor 100, 101, 200 with the electronic switching mechanism 586c according to various embodiments. According to various embodiments, the electronic switching mechanism 586c may include an optical switch 588c or optical router which may use electro-optic effects or magneto-optic effects or other suitable methods for performing switching via logic operations. According to various embodiments, the pulse emitter 582 may be connected to the optical switch 588c to transmit the pulse or optical pulse to the optical switch 588c. The optical switch 588c may be connected to both the first input/output interface 140, 240 and the second input/output interface 150, 250 of the on-chip bidirectional pulse compressor 100, 101, 200. Accordingly, the optical switch 588c may be operated to transmit the pulse or the optical pulse to either the first input/output interface 140, 240 or the second input/output interface 150, 250 based on whether routing along the first transmission path or the second transmission path is required. Further, the pulse receiver 584 may be connected to the optical switch 588c. Accordingly, the optical switch 588c may route the compressed pulse received from the on-chip bidirectional pulse compressor 100, 101, 200 to the pulse receiver 584.

According to various embodiments, the optical system 580, 580a, 580b, 580c may be operated to propagate pulse from the pulse emitter 582 through the on-chip bidirectional pulse compressor 100, 101, 200 interchangeably via the first input/output interface 140, 240 or the second input/output interface 150, 250 depending on whether temporal compression or spectral compression is desired such that the on-chip bidirectional pulse compressor 100, 101, 200 may output a temporally compressed or spectrally compressed pulse to the pulse receiver 584.

The following examples pertain to various embodiments.

Example 1 is an on-chip bidirectional pulse compressor for temporal compression in a first propagation direction and spectral compression in a second propagation direction, the on-chip bidirectional pulse compressor including:

a substrate;

a nonlinear waveguide disposed on the substrate, wherein the nonlinear waveguide is dimensioned and made of a material to induce a nonlinear response within a predetermined operating wavelength ranges, wherein the material of the nonlinear waveguide is free of two-photon absorption at the predetermined operating wavelength ranges; and

an anomalous dispersive component disposed on the substrate,

wherein the nonlinear waveguide and the anomalous dispersive component are interconnected for bidirectional pulse propagation,

wherein, when a pulse propagates in the first propagation direction through the nonlinear waveguide followed by the anomalous dispersive component, the nonlinear waveguide induces self-phase modulation to broaden a spectrum of the pulse and the anomalous dispersive component subsequently induces anomalous dispersion to temporally shift frequency components of the broadened spectrum towards a centre of the pulse in a manner so as to cause temporal compression of the pulse,

wherein, when a pulse propagates in the second propagation direction through the anomalous dispersive component followed by the nonlinear waveguide, the anomalous dispersive component induces anomalous dispersion on the pulse to temporally shift frequency components of a spectrum of the pulse such that higher frequency components of the spectrum advance ahead relative to lower frequency components of the spectrum and the nonlinear waveguide subsequently induces self-phase modulation to redshift the higher frequency components of the spectrum which are leading and blueshift the lower frequency components of the spectrum which are trailing in a manner so as to cause spectral compression of the pulse.

In Example 2, the subject matter of Example 1 may optionally include that the material of the nonlinear waveguide may be complementary metal oxide semiconductor (CMOS) compatible.

In Example 3, the subject matter of Example 2 may optionally include that the nonlinear waveguide may be made of an ultra-silicon-rich nitride (USRN) material, wherein the USRN material may include an amorphous, polycrystalline or crystalline material that contains both silicon (Si) and nitrogen (Ni) and a quantity of the silicon is higher than stoichiometric silicon nitride (Si₃N₄).

In Example 4, the subject matter of Example 3 may optionally include that the anomalous dispersive component may be integrally formed with the nonlinear waveguide on the substrate in a manner so as to form a continuous monolithic structure, wherein the anomalous dispersive component may be made of the USRN material.

In Example 5, the subject matter of any one of Examples 1 to 4 may optionally include a thermo-optic tuning component coupled to the anomalous dispersive component for active control of the anomalous dispersion.

In Example 6, the subject matter of any one of Examples 1 to 5 may optionally include that the anomalous dispersive component may induce anomalous dispersion based on a linear relationship between differential group delay and wavelength within the predetermined wavelength ranges.

In Example 7, the subject matter of any one of Examples 1 to 6 may optionally include that the anomalous dispersive component may include a pair of parallel solid elongate strip structures, each having two sinusoidally corrugated longitudinal sidewalls, wherein a corrugation period of each longitudinal sidewall may vary linearly lengthwise from a first longitudinal end to a second longitudinal end.

In Example 8, the subject matter of Example 7 may optionally include that the corrugation period of each longitudinal sidewall may increase linearly lengthwise from the first longitudinal end to the second longitudinal end, wherein the first longitudinal end of a first of the pair of parallel solid elongate strip structures may be integral with an extension extending to an input/output interface and the first longitudinal end of a second of the pair of parallel solid elongate strip structures may be integral with the nonlinear waveguide.

In Example 9, the subject matter of Example 7 or 8 may optionally include that each solid elongate strip structure may have mirror symmetry about its longitudinal axis.

In Example 10, the subject matter of any one of Examples 1 to 6 may optionally include that the anomalous dispersive component may include a pair of parallel solid elongate strip structures and a row of circular structures between the pair of parallel solid elongate strip structures aligned to the pair of parallel solid elongate strip structures.

In Example 11, the subject matter of Example 10 may optionally include that a distance apart between two adjacent circular structures along the row of circular structures may increase linearly in a direction parallel to the solid elongated strip structures which extends from a first longitudinal end to a second longitudinal end of the pair of solid elongated strip structures.

In Example 12, the subject matter of Example 11 may optionally include that the first longitudinal end of a first of the pair of parallel solid elongate strip structures may be integral with an extension extending to an input/output interface and the first longitudinal end of a second of the pair of parallel solid elongate strip structures may beintegral with the nonlinear waveguide.

In Example 13, the subject matter of any one of Examples 1 to 12 may optionally include a first tapered waveguide coupler coupled to a first input/output interface associated with the nonlinear waveguide and a second tapered waveguide coupler coupled to a second input/output interface associated with the anomalous dispersive component.

In Example 14, the subject matter of any one of Examples 1 to 13 may optionally include that the nonlinear waveguide may have a width between 10 nm to 100 μm, or preferably between 50 nm to 50 μm, or preferably between 300 nm to 2 μm, and a thickness between 10 nm to 100 μm, or preferably 50 nm to 50 μm, or preferably between 300 nm to 2 μm.

In Example 15, the subject matter of any one of Examples 1 to 14 may optionally include that the nonlinear waveguide may include a solid strip waveguide structure having a rectangular or square or circular cross-section profile, or a slot waveguide structure, or a rib waveguide structure.

In Example 16, the subject matter of any one of Examples 1 to 15 may optionally include that the predetermined operating ranges may include visible wavelength range, mid-infrared wavelength range, optical telecommunication wavelength range, or terahertz wavelength range.

Example 17 is an optical system including:

a pulse emitter operable to emit a pulse within a predetermined operating wavelength ranges;
a pulse receiver;
an on-chip bidirectional pulse compressor disposed along a transmission path between the pulse emitter and the pulse receiver, the on-chip bidirectional pulse compressor comprising

a substrate,
a nonlinear waveguide disposed on the substrate, wherein the nonlinear waveguide is dimensioned and made of a material to induce a nonlinear response within the predetermined operating wavelength ranges, wherein the material of the nonlinear waveguide is free of two-photon absorption at the predetermined operating wavelength ranges,
an anomalous dispersive component disposed on the substrate, wherein the nonlinear waveguide and the anomalous dispersive component are interconnected for bidirectional pulse propagation,
a first input/output interface associated with the nonlinear waveguide, and
a second input/output interface associated with the anomalous dispersive component; and
   a transmission path switching mechanism configured to switch between a first transmission path and a second transmission path,
   wherein, in the first transmission path, the pulse emitter emits the pulse to the first input/output interface for propagating the pulse through the on-chip bidirectional pulse compressor in a first propagation direction through the nonlinear waveguide followed by the anomalous dispersive component, wherein the nonlinear waveguide induces self-phase modulation to broaden a spectrum of the pulse and the anomalous dispersive element subsequently induces anomalous dispersion to temporally shift frequency component of the broadened spectrum towards a centre of the pulse in a manner so as to output a temporally compressed pulse from the second input/output interface to the pulse receiver,
   wherein, in the second transmission path, the pulse emitter emits the pulse to the second input/output interface for propagating the pulse through the on-chip bidirectional pulse compressor in a second propagation direction through the anomalous dispersive component followed by the nonlinear waveguide, wherein the anomalous dispersive component induces anomalous dispersion on the pulse to temporally shift frequency component of a spectrum of the pulse such that higher frequency components of the spectrum advance ahead relative to lower frequency components of the spectrum and the nonlinear waveguide subsequently induces self-phase modulation to redshift the higher frequency components of the spectrum which are leading and blueshift the lower frequency components of the spectrum which are trailing in a manner so as to output a spectrally compressed pulse from the first input/output interface to the pulse receiver.

In Example 18, the subject matter of Example 17 may optionally include that 18 the transmission path switching mechanism may include a mechanical switching mechanism or an electronic switching mechanism.

In Example 19, the subject matter of Example 17 or 18 may optionally include that the material of the nonlinear waveguide of the on-chip bidirectional pulse compressor may be complementary metal oxide semiconductor (CMOS) compatible.

In Example 20, the subject matter of Example 19 may optionally include that the nonlinear waveguide of the on-chip bidirectional pulse compressor may be made of an ultra-silicon-rich nitride (USRN) material, wherein the USRN material may include an amorphous, polycrystalline or crystalline material that contains both silicon (Si) and nitrogen (Ni) and a quantity of the silicon is higher than stoichiometric silicon nitride (Si₃N₄).

In Example 21, the subject matter of Example 20 may optionally include that the anomalous dispersive component may be integrally formed with the nonlinear waveguide on the substrate in a manner so as to form a continuous monolithic structure, wherein the anomalous dispersive component may be made of the USRN material.

In Example 22, the subject matter of any one of Examples 17 to 21 may optionally include that the on-chip bidirectional pulse compressor may further include a thermos-optic tuning component coupled to the anomalous dispersive component for active control of the anomalous dispersion.

In Example 23, the subject matter of any one of Examples 17 to 22 may optionally include that the anomalous dispersive component of the on-chip bidirectional pulse compressor may induce anomalous dispersion based on a linear relationship between differential group delay and wavelength within the predetermined wavelength ranges.

In Example 24, the subject matter of any one of Examples 17 to 23 may optionally include that the anomalous dispersive component may include a pair of parallel solid elongate strip structures, each having two sinusoidally corrugated longitudinal sidewalls, wherein a corrugation period of each longitudinal sidewall may vary linearly lengthwise from a first longitudinal end to a second longitudinal end.

In Example 25, the subject matter of Example 24 may optionally include that the corrugation period of each longitudinal sidewall may increase linearly lengthwise from the first longitudinal end to the second longitudinal end, wherein the first longitudinal end of a first of the pair of parallel solid elongate strip structures may be integral with an extension extending to an input/output interface and the first longitudinal end of a second of the pair of parallel solid elongate strip structures may be integral with the nonlinear waveguide.

In Example 26, the subject matter of Example 24 or 25 may optionally include that each solid elongate strip structure may have mirror symmetry about its longitudinal axis.

In Example 27, the subject matter of any one of Examples 17 to 23 may optionally include that the anomalous dispersive component may include a pair of parallel solid elongate strip structures and a row of circular structures between the pair of parallel solid elongate strip structures aligned to the pair of parallel solid elongate strip structures.

In Example 28, the subject matter of Example 27 may optionally include that a distance apart between two adjacent circular structures along the row of circular structures may increase linearly in a direction parallel to the solid elongated strip structures which extends from a first longitudinal end to a second longitudinal end of the pair of solid elongated strip structures.

In Example 29, the subject matter of Example 28 may optionally include that the first longitudinal end of a first of the pair of parallel solid elongate strip structures may be integral with an extension extending to an input/output interface and the first longitudinal end of a second of the pair of parallel solid elongate strip structures may be integral with the nonlinear waveguide.

In Example 30, the subject matter of any one of Examples 17 to 29 may optionally include that the on-chip bidirectional pulse compressor may further include a first tapered waveguide coupler coupled to a first input/output interface associated with the nonlinear waveguide and a second tapered waveguide coupler coupled to a second input/output interface associated with the anomalous dispersive component.

In Example 31, the subject matter of any one of Examples 17 to 30 may optionally include that the nonlinear waveguide may have a width between 10 nm to 100 μm, or preferably between 50 nm to 50 μm, or preferably between 300 nm to 2 μm, and a thickness between 10 nm to 100 μm, or preferably 50 nm to 50 μm, or preferably between 300 nm to 2 μm.

In Example 32, the subject matter of any one of Examples 17 to 31 may optionally include that the nonlinear waveguide may include a solid strip waveguide structure having a rectangular or square or circular cross-section profile, or a slot waveguide structure, or a rib waveguide structure.

In Example 33, the subject matter of any one of Examples 17 to 32 may optionally include that the predetermined operating ranges may include visible wavelength range, mid-infrared wavelength range, optical telecommunication wavelength range, or terahertz wavelength range.

Various embodiments have provided a compact and versatile on-chip bidirectional pulse compressor that can be used for both temporal and spectral compression. According to various embodiments, the on-chip bidirectional pulse compressor may be of a small footprint and may temporally compressed a pulse when propagated therethrough in the first propagation direction and may spectrally compressed the pulse when propagated therethrough in the second propagation direction. Various embodiments have also provided an optical system having the on-chip bidirectional pulse compressor.

While the invention has been particularly shown and described with reference to specific embodiments, it should be understood by those skilled in the art that various changes, modification, variation in form and detail may be made therein without departing from the scope of the invention as defined by the appended claims. The scope of the invention is thus indicated by the appended claims and all changes which come within the meaning and range of equivalency of the claims are therefore intended to be embraced.

What is claimed is:

1. An on-chip bidirectional pulse compressor for temporal compression in a first propagation direction and spectral compression in a second propagation direction, the on-chip bidirectional pulse compressor comprises:
a substrate;
a nonlinear waveguide disposed on the substrate, wherein the nonlinear waveguide is dimensioned and made of a material to induce a nonlinear response within a predetermined operating wavelength ranges, wherein the material of the nonlinear waveguide is free of two-photon absorption at the predetermined operating wavelength ranges; and
an anomalous dispersive component disposed on the substrate,
wherein the nonlinear waveguide and the anomalous dispersive component are interconnected for bidirectional pulse propagation,
wherein, when a pulse propagates in the first propagation direction through the nonlinear waveguide followed by the anomalous dispersive component, the nonlinear waveguide induces self-phase modulation to broaden a spectrum of the pulse and the anomalous dispersive component subsequently induces anomalous dispersion to temporally shift frequency components of the broadened spectrum towards a centre of the pulse in a manner so as to cause temporal compression of the pulse,
wherein, when a pulse propagates in the second propagation direction through the anomalous dispersive component followed by the nonlinear waveguide, the anomalous dispersive component induces anomalous dispersion on the pulse to temporally shift frequency components of a spectrum of the pulse such that higher frequency components of the spectrum advance ahead relative to lower frequency components of the spectrum and the nonlinear waveguide subsequently induces self-phase modulation to redshift the higher frequency components of the spectrum which are leading and blueshift the lower frequency components of the spectrum which are trailing in a manner so as to cause spectral compression of the pulse.

2. The bidirectional pulse compressor as claimed in claim 1, wherein the material of the nonlinear waveguide is complementary metal oxide semiconductor (CMOS) compatible.

3. The bidirectional pulse compressor as claimed in claim 2, wherein the nonlinear waveguide is made of an ultra-silicon-rich nitride (USRN) material, wherein the USRN material comprises an amorphous, polycrystalline or crystalline material that contains both silicon (Si) and nitrogen (Ni) and a quantity of the silicon is higher than stoichiometric silicon nitride (Si₃N₄).

4. The bidirectional pulse compressor as claimed in claim 3, wherein the anomalous dispersive component is integrally formed with the nonlinear waveguide on the substrate in a manner so as to form a continuous monolithic structure, wherein the anomalous dispersive component is made of the USRN material.

5. The bidirectional pulse compressor as claimed in claim 4, further comprising a thermo-optic tuning component coupled to the anomalous dispersive component for active control of the anomalous dispersion.

6. The bidirectional pulse compressor as claimed in claim 1, wherein the anomalous dispersive component induces anomalous dispersion based on a linear relationship between differential group delay and wavelength within the predetermined wavelength ranges.

7. The bidirectional pulse compressor as claimed in claim 4, wherein the anomalous dispersive component comprises a pair of parallel solid elongate strip structures, each having two sinusoidally corrugated longitudinal sidewalls, wherein a corrugation period of each longitudinal sidewall varies linearly lengthwise from a first longitudinal end to a second longitudinal end.

8. The bidirectional pulse compressor as claimed in claim 7, wherein the corrugation period of each longitudinal sidewall increases linearly lengthwise from the first longitudinal end to the second longitudinal end, wherein the first longitudinal end of a first of the pair of parallel solid elongate strip structures is integral with an extension extending to an input/output interface and the first longitudinal end of a second of the pair of parallel solid elongate strip structures is integral with the nonlinear waveguide.

9. The bidirectional pulse compressor as claimed in claim 8, wherein each solid elongate strip structure has mirror symmetry about its longitudinal axis.

10. The bidirectional pulse compressor as claimed in claim 1, further comprising a first tapered waveguide coupler coupled to a first input/output interface associated with the nonlinear waveguide and a second tapered waveguide coupler coupled to a second input/output interface associated with the anomalous dispersive component.

11. An optical system comprising:
a pulse emitter operable to emit a pulse within a predetermined operating wavelength ranges;
a pulse receiver;
an on-chip bidirectional pulse compressor disposed along a transmission path between the pulse emitter and the pulse receiver, the on-chip bidirectional pulse compressor comprising
a substrate,
a nonlinear waveguide disposed on the substrate, wherein the nonlinear waveguide is dimensioned and made of a material to induce a nonlinear response within the predetermined operating wavelength ranges, wherein the material of the nonlinear waveguide is free of two-photon absorption at the predetermined operating wavelength ranges,
an anomalous dispersive component disposed on the substrate, wherein the nonlinear waveguide and the anomalous dispersive component are interconnected for bidirectional pulse propagation,
a first input/output interface associated with the nonlinear waveguide, and
a second input/output interface associated with the anomalous dispersive component; and
a transmission path switching mechanism configured to switch between a first transmission path and a second transmission path,
wherein, in the first transmission path, the pulse emitter emits the pulse to the first input/output interface for propagating the pulse through the on-chip bidirectional pulse compressor in a first propagation direction through the nonlinear waveguide followed by the anomalous dispersive component, wherein the nonlinear waveguide induces self-phase modulation to broaden a spectrum of the pulse and the anomalous dispersive element subsequently induces anomalous dispersion to temporally shift frequency component of the broadened spectrum towards a centre of the pulse in a manner so as to output a temporally compressed pulse from the second input/output interface to the pulse receiver,
wherein, in the second transmission path, the pulse emitter emits the pulse to the second input/output interface for propagating the pulse through the on-chip bidirectional pulse compressor in a second propagation direction through the anomalous dispersive component followed by the nonlinear waveguide, wherein the anomalous dispersive component induces anomalous dispersion on the pulse to temporally shift frequency component of a spectrum of the pulse such that higher frequency components of the spectrum advance ahead relative to lower frequency components of the spectrum and the nonlinear waveguide subsequently induces self-phase modulation to redshift the higher frequency components of the spectrum which are leading and blueshift the lower frequency components of the spectrum which are trailing in a manner so as to output a spectrally compressed pulse from the first input/output interface to the pulse receiver.

12. The system as claimed in claim 11, wherein the transmission path switching mechanism includes a mechanical switching mechanism or an electronic switching mechanism.

13. The system as claimed in claim 11, wherein the material of the nonlinear waveguide of the on-chip bidirectional pulse compressor is complementary metal oxide semiconductor (CMOS) compatible.

14. The system as claimed in claim 13, wherein the nonlinear waveguide of the on-chip bidirectional pulse compressor is made of an ultra-silicon-rich nitride (USRN) material, wherein the USRN material comprises an amorphous, polycrystalline or crystalline material that contains both silicon (Si) and nitrogen (Ni) and a quantity of the silicon is higher than stoichiometric silicon nitride (Si₃N₄).

15. The system as claimed in claim 14, wherein the anomalous dispersive component is integrally formed with the nonlinear waveguide on the substrate in a manner so as to form a continuous monolithic structure, wherein the anomalous dispersive component is made of the USRN material.

16. The system as claimed in claim 15, wherein the on-chip bidirectional pulse compressor further comprises a thermos-optic tuning component coupled to the anomalous dispersive component for active control of the anomalous dispersion.

17. The system as claimed in claim 11, wherein the anomalous dispersive component of the on-chip bidirectional pulse compressor induces anomalous dispersion based on a linear relationship between differential group delay and wavelength within the predetermined wavelength ranges.

18. The system as claimed in claim 15, wherein the anomalous dispersive component comprises a pair of parallel solid elongate strip structures, each having two sinusoidally corrugated longitudinal sidewalls, wherein a corrugation period of each longitudinal sidewall varies linearly lengthwise from a first longitudinal end to a second longitudinal end.

19. The system as claimed in claim 18, wherein the corrugation period of each longitudinal sidewall increases linearly lengthwise from the first longitudinal end to the second longitudinal end, wherein the first longitudinal end of a first of the pair of parallel solid elongate strip structures is integral with an extension extending to an input/output interface and the first longitudinal end of a second of the pair of parallel solid elongate strip structures is integral with the nonlinear waveguide.

20. The system as claimed in claim 19, wherein each solid elongate strip structure has mirror symmetry about its longitudinal axis.
